(19) United States
(12) Patent Application Publication
(10) Pub. No.: US 2012/0205598 A1
(43) Pub. Date: Aug. 16, 2012

(54) "Green" synthesis of colloidal nanocrystals and their water-soluble preparation

(75) Inventors: Linsong Li, Kaifeng (CN); Huaibin Shen, Kaifeng (CN); Changhua Zhou, Kaifeng (CN)

(73) Assignee: Shenzhen Thales Science & Technology Co., LTD.

(21) Appl. No.: 12/932,085

(22) Filed: Feb. 16, 2011

(51) Int. Cl. H01B 1/00

(52) U.S. Cl. 252/519.34; 252/519.4

(57) ABSTRACT

Highly monodisperse nanocrystals (including CdSe, ZnSe, PbSe, Cu₂₋ₓSe, MnSe, Zn₁₋ₓCdₓSe, CuInSe₂, CuInSnSe₂, CdTe, ZnTe, PbTe, etc) have been synthesized by using different “green” starting materials to prepare chalcogenide (Se and Te) precursors successfully. Air-sensitive compounds (alkylphosphine, such as trioctylphosphine (TOP) and tributylphosphine (TBP)) have been eliminated to use in the entire synthetic process. As surface coating agents, amphiphilic oligomer (polymaleic acid aliphatic alcohol ester) with different alkyl chain length has been utilized to form oligomer-coated water-soluble nanocrystals.

### BACKGROUND OF THE PRESENT INVENTION

1. Field of Invention

The present invention relates to methods of manufacturing colloidal nanocrystals, and more particularly to a method of manufacturing monodisperse metal chalcogenides nanocrystals without using air-sensitive alkylphosphine to manufacture high quality monodisperse metal chalcogenides nanocrystals and a method preparing water-soluble nanocrystal from organic solvent-soluble nanocrystal, which is adapted for applying in industrial manufacture of biological labeling materials, imaging reagent, light-emitting diode, solid state lighting, and a solar cell device.

2. Description of Related Arts

Since the concept of “size quantization effect” has been first introduced in the early 1980s, colloidal CdSe and CdTe nanocrystals are the most heavily investigated object amongst inorganic semiconductor nanoparticles. Many very successful preparation methods have been established for the synthesis of high quality CdSe and CdTe nanocrystals, including the organometallic precursor route, the nonorganometallic precursor route, the single molecule precursor route, the microwave irradiation route, and etc. Most of these methods involve the use of alkylphosphine such as trioctylphosphine (TOP) and tributylphosphine (TBP) to prepare complex precursors between chalcogenide and TOP or TBP. But it is well known that TOP and TBP are hazardous, unstable, and expensive materials and generally glove box is required in the operation. Most recently, paraffin liquid, olive oil, diesel, and 1-octadecene (ODE) have all been chosen as the solvents to prepare Se precursor for the synthesis of CdSe and ZnSe nanocrystals without using air-sensitive alkylphosphine. The qualities of as-prepared nanocrystals are still not as well as the widely used selenium phosphine methods. The demand for high quality and low-cost nanocrystals has been increased, but still, new “green” synthesis route in which the use of air-sensitive alkylphosphine (TBP or TOP) throughout the entire reaction process is eliminated is not developed yet.

### SUMMARY OF THE PRESENT INVENTION

The object of this invention is to provide a new, simple, and robust “green” approach to synthesize high quality semiconductor core and core/shell nanocrystals, including CdSe, ZnSe, Cu₂₋ₓSe, PbSe, MnSe, CdTe, Zn₁₋ₓCdₓSe, CdTeₓSe₁₋ₓ, CdSe/ZnS, ZnSe/ZnS, Zn₁₋ₓCdₓSe/ZnS, Cu₂₋ₓSe/SnSe, PbSe/ZnS, MnSe/ZnSe, CdTe/CdSe, and CdTe/CdS etc. Here “green” means that there is no use of TBP and TOP in the entire synthetic process, and only low-cost and environmental friendly reagents are used in the reaction. Different kinds of “green” Se and Te precursors have been tested and optimized to obtain metal selenide and metal telluride nanocrystals with large controllable size range. The as-prepared CdSe, ZnSe, Cu₂₋ₓSe, PbSe, MnSe, CdTe, Zn₁₋ₓCdₓSe, CdTeₓSe₁₋ₓ, CdSe/ZnS, ZnSe/ZnS, Zn₁₋ₓCdₓSe/ZnS, Cu₂₋ₓSe/SnSe, PbSe/ZnS, MnSe/ZnSe, CdTe/CdSe, and CdTe/CdS nanocrystals keep the same high quality level when comparing with the use of the widely used air-sensitive selenium and/or tellurium alkylphosphine precursors.

Another object of the present invention is to provide a foundation for a simple and high performance version of the industrial scale synthesis of many kinds of core and core-shell nanocrystals, such as cores including CdSe, ZnSe, PbSe, Cu₂₋ₓSe, Cu₂₋ₓSe/SnSe, CdTe, CdTeₓSe₁₋ₓ, MnSe, AgSe, InSe, GaSe, MgSe, Al₂Se₃, SnSe, Zn₁₋ₓSe, CdSe₁₋ₓSₓ, CuInSe, CuInSeS, CuInZnSe, or mixture thereof. The total cost can be saved higher than 50% to produce naoncrystals comparing with the method using air-sensitive selenium and/or tellurium alkylphosphine precursors.

Another object of the present invention is to provide two injection approaches (i.e. metal precursor injection and chalcogenide precursor injection) to synthesize high-quality core nanocrystals using Se or SeO₂ with ODE as “green” selenium precursor and Te or TeO₂ with TOPO as “green” tellurium precursor. It is indicated that the zinc and cadmium precursor injection approach has a better quality control than the selenium or tellurium precursor injection approach. For CdSe nanocrystal, large scale syntheses of such core into core/shell nanocrystals have been successfully demonstrated and more than 10 g of high quality core/shell nanocrystals are easily synthesized with the use of only low-cost, “green”, and environmentally friendlier reagents.

Recently, the use of semiconductor nanocrystals in biological and medical applications is one of the most exciting technologies in the field of nanotechnology. Until now, several strategies have been utilized for transferring organic solvent-soluble nanocrystals to aqueous solution. Earlier strategy for the preparation of water-soluble nanocrystals involves exchanging of original hydrophobic coatings with thoil-terminated carboxylic acid, which is greatly advantageous due to its simplicity. Amphiphilic polymers can be used to induce aqueous solubility and are strongly assembled around the existing organic capping ligands. The polymer shell maintains the nonpolar environment around the nanocrystals and provides a thick barrier against the surrounding aqueous environment. As a result, semiconductor nanocrystals with amphiphilic polymer coatings tend to better maintain their initial high fluorescence and stability when transferred from organic to aqueous solvent. Here amphiphilic oligomer (polymaleic acid aliphatic alcohol ester, molecular weight is several thousands) with different alkyl chain length as encapsulant is utilized to form oligomer-coated water-soluble core/shell nanocrystals. For example, CdSe/ZnS nanocrystals, which are originally dispersed in chloroform, can be completely transferred into water. The process described above uses low cost materials, which are much more economical than some surfactants such as phospholipids and specially synthesized polymers used in other procedures. This method is general and versatile for many organic phase-synthesized nanocrystals, such as Fe₃O₄ or Fe₂O₃ magnetic nanocrystals, Au or Ag noble metal nanocrystals. With this method, water-soluble photoluminescent microspheres (consisting of semiconductor nanocrystals) with different diameters can be prepared easily too. The size and size dispersity of these water-soluble microspheres can be tuned by changing experiment conditions such as oligomer concentrations and the volume ratio between water and chloroform. The microsphere diameters are decreased by increasing the initial oligomer concentration or by increasing the volume ration of water/chloroform. Furthermore, the nanocrystals are homogeneously distributed in these microspheres.

Another advantage of the invention is to provide a method of manufacturing monodisperse metal chalcogenides nanocrystals without using air-sensitive alkylphosphine to manufacture high quality monodisperse metal chalcogenides nanocrystals, which is of relatively low cost and is suitable for use in a wide range of application which includes industrial manufacture of biological labeling materials, imaging reagent, and light-emitting diode, solid state lighting and a solar cell device.

Another advantage of the present invention is to provide a method for preparing water-soluble nanocrystals or photoluminescent microspheres from organic solvent-soluble nanocrystal so as to facilitate different production requirements in industrial manufacture.

Additional advantages and features of the invention will become apparent from the description which follows, and may be realized by means of the instrumentalities and combinations particular point out in the appended claims.

According to the present invention, the foregoing and other objects and advantages are attained by a method of monodisperse metal chalcogenides nanocrystals synthesis, comprising the steps of:

(a) providing a first composition of nanocrystals by combining metal precursor(s), ligand(s), and chalcogenide precursor(s) in a noncoordinating solvent at a preset reaction temperature, wherein the metal precursor is capable of being dissolved in the ligand and the first noncoordinating solvent and the first preset reaction temperature is sufficient for forming the first composition of nanocrystal in dot-shape, rod shape, branch shape and wire shape to obtain a final product of highly monodisperse metal chalcogenide nanocrystals;

(b) for core/shell nanocrystal synthesis, providing a second composition through a second reaction by pre-selected core nanocrystals reacting with a metal composition consisting of metal oxide or salts with an additive composition consisting of acid(s) or amine(s) and chalcogenide precursor(s) in a second noncordinating solvent at a second preset temperature of 100-350° C. for a second preset period of time of 5 min-10 days to obtain a final product of highly monodisperse core/shell metal chalcogenide nanocrystals;

(c) adding one or more phosphine-free metal precursor(s), ligand(s), and chalcogenide precursor(s) to the first and the second compositions to obtain a final product of highly monodisperse core/multi-shell metal chalcogenide nanocrystals.

In accordance with another aspect of the invention, the present invention is a method of preparing water-soluble nanocrystals or photoluminescent microspheres from organic solvent-soluble nanocrystals, adapted for applying in industrial manufacture, comprising the steps of

(a′) preparing a solution A by dissolving the organic solvent-soluble nanocrystals in organic solvent;

(b′) preparing a solution B by dissolving the amphiphilic oligomer in distilled water and adjusting the pH of solution B to 8-10; and

(c′) mixing the solution A and solution B (V_{B}>V_{A}) under magnetic stirring to form an emulsion system (O/W); and

(d′) evaporating the organic solvent from the mixed solution at room temperate to obtain the water soluble nanocrystals or photoluminescent microspheres, wherein the molar ratio of nanocrystal/PMAA is 1:10-1:200 and the volume ratios of water/organic solvent is 3:1-9:1,

thereby the water soluble nanocrystals or photoluminescent microspheres are capable of being applied at industrial level for biological labeling, imaging reagent, and manufacture of light-emitting diode, solid state lighting, and a solar cell device.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 illustrates the UV-vis absorption and photoluminescence spectra collected during the growth of CdSe nanocrystals. The fractions of CdSe nanocrystals are diluted to similar absorption intensity for the measurement. Note that the spectra are normalized and shifted for clarity.

FIG. 2 illustrates the Temporal evolution of the photoluminescence spectra of the as-prepared CdSe nanocrystals: (a) injection of Se-ODA-ODE precursor into CdO, OA, and ODE solution; (b) injection of Se-OA-ODE precursor into CdO, OA, and ODE solution; (c) injection of Se-ODE precursor into CdO, OA, and ODE solution; and (d) injection of Se-ODA-ODE precursor into CdSt₂ and ODE solution.

FIG. 3 illustrates the X-ray diffraction patterns and related TEM images of (a) 3.1 nm CdSe nanocrystals, overcoated by (b) 2.5 layers CdS and (c) 4.5 layers ZnS shells. The lines show the peak positions for bulk zinc blende CdSe (bottom) and ZnS (top). The sample is deposited on quartz substrate from their toluene solutions.

FIG. 4 illustrates the UV-vis absorption and photoluminescence spectra of CdSe/ZnS core-shell nanocrystals with (a) 491 nm core; (b) 505 nm core; (c) 548 nm core; and (d) 595 nm core. Inset is the photos demonstrating the size-tunable photoluminescence of different cores; all samples are excited at 365 nm with a UV source.

FIG. 5 illustrates the UV-vis absorption and photoluminescence spectra collected during the growth of ZnSe nanocrystals with different conditions. The fractions of ZnSe nanocrystals are diluted to similar absorption intensity for the measurement. Note that the spectra are normalized and shifted for clarity.

FIG. 6 illustrates the photoluminescence spectra of ZnSe/ZnS core-shell nanocrystals of (a) ZnSe core, (b) ZnSe with 1 layer ZnS, (C) ZnSe with 2 layer ZnS, and (d) ZnSe with 3 layer ZnS. Inset is the absorption and photoluminescence spectrum of ZnSe core nanocrystal for comparison.

FIG. 7 illustrates the X-ray diffraction patterns and related TEM images of (a) 9.2 nm, (b) 7.5 nm, (c) 5.0 nm ZnSe, and (d) 6.5 nm ZnSe/ZnS core-shell with 2 layers ZnS overcoating on 5.0 nm ZnSe.

FIG. 8 illustrates the photoluminescence spectra related to (left) Cu²⁺ doped ZnSe and (right) Mn²⁺ doped ZnSe nanocrystals.

FIG. 9 illustrates the TEM images of Cu₂₋ₓSe nanocrystals (a,b) and Cu₂₋ₓSe/SnSe nanocrystals (c,d).

FIG. 10 illustrates the TEM and HRTEM images of different shaped PbSe and PbTe nanocrystals.

FIG. 11 illustrates the absorption, photoluminescence spectra, and TEM images of ZnₓCd₁₋ₓSe nanocrystals with different molar ratio of Zn and Cd. The insets are photographs of corresponding samples under 365 nm UV illumination.

FIG. 12 (a) illustrates the evolution of the absorption and photoluminescence spectra upon consecutive growth of ZnₓCd₁₋ₓSe core/shell nanocrystals. (b) Evolution of the PL-peak position (dark) and QYs (green) for core-shell nanocrystals. (c) Evolution of the relative QYs of core (dark) and core-shell (green) nanocrystals upon repeated precipitation and redispersion.

FIG. 13 illustrates the temporal evolution of the absorption spectrum of CdTe (a) and CdTeₓSe₁₋ₓ, (b) nanocrystals. The time is counted as zero when the temperature reached 220° C.

FIG. 14 illustrates the photoluminescence spectra of (top) CuInSe₂ and (bottom) CuInSe₂/ZnS nanocrystals.

FIG. 15 illustrates the synthesis of amphiphilic oligomers through reaction between polymaleic anhydride and aliphatic alcohol.

FIG. 16 illustrates the formation of water-soluble CdSe/ZnS nanocrystals by amphiphilic oligomers.

FIG. 17 TEM images of microsphere-shaped and monodisperse CdSe/ZnS nanocrystals in water.

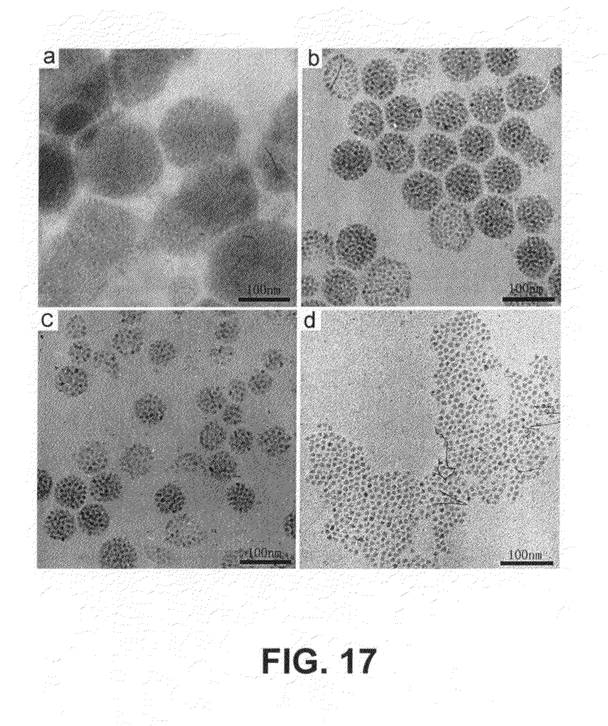

### DETAILED DESCRIPTION OF THE PREFERRED EMBODIMENT

A: Synthesis of CdSe Nanocrystals

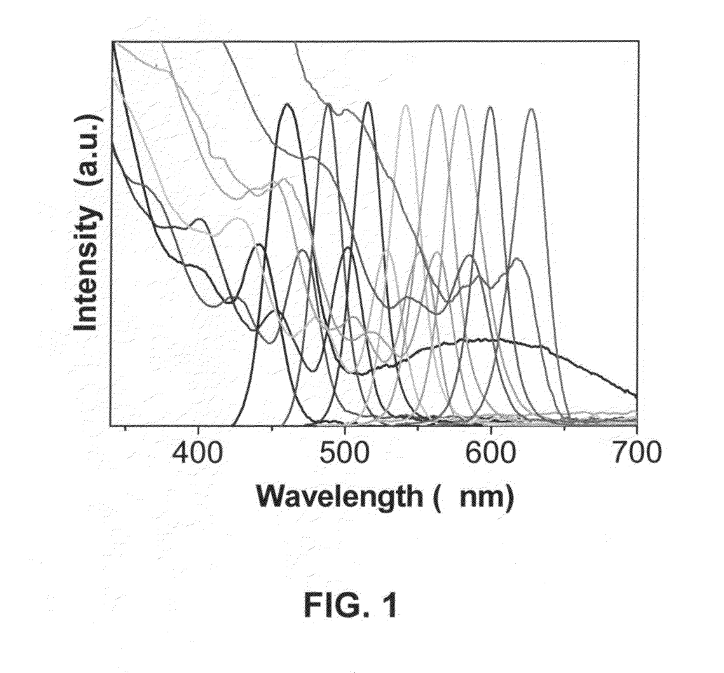

Several kinds of ligands have been selected to test the reactivity for the synthesis of CdSe nanocrystals. It has been proven to be able to synthesize very high quality CdSe nanocrystals with bright PL cover the range form 460 nm to 650 nm. FIG. 1 shows the time-dependent evolution of UV-vis and PL spectra of CdSe nanocrystals in a typical reaction. They are collected at various times after Se-octadecylamine (Se-ODA) precursor is injected into cadmium oxide (CdO) with oleic acid (OA) in ODE. There are very sharp features in the absorption spectra in the whole reaction period, from as early as 5 s to 12 hours. The estimated size range of CdSe nanocrystals is approximately between 1.6 nm and 5.4 nm. The corresponding PL peak positions for the CdSe nanocrystals with reasonable emission brightness are between 440 nm and 620 nm. Without any size sorting, all UV-vis and PL spectra of the as-prepared CdSe nanocrystals shown here are comparable to the best optical spectra of CdSe nanocrystals, which are obtained through alternative approaches (such as Se-TOP as Se precursor). The full width at half-maximums (FWHMs) of the emission bands are successfully controlled below 30 nm in the whole reaction, the narrowest one is around 22 nm. Typical quantum yields (QYs) of the as-prepared CdSe nanocrystals are around 30-60% without any size sorting.

The temperature of the Se precursors for the injection is very important for the synthesis of high quality CdSe. Typically, the temperatures ranging from 20 to 280° C. for Se precursor can all be used to synthesize CdSe, but high quality CdSe nanocrystals are synthesized only with the use of Se precursors at high temperature. When the temperature of Se precursor is higher than 200° C. before the injection, high quality CdSe nanocrystals are able to be synthesized. Moreover, the molar ratios between Cd and Se precursors also affect the quality of as-prepared CdSe nanocrystals. When the Cd:Se ratio is equal or just above 1, only CdSe nanocrystals with broad FWHM PL are synthesized. If this Cd:Se ratio is below 1:2 the reaction speed of forming CdSe nanocrystals will become too fast and then it is out of control easily. It may turn into a black solution within several minutes.

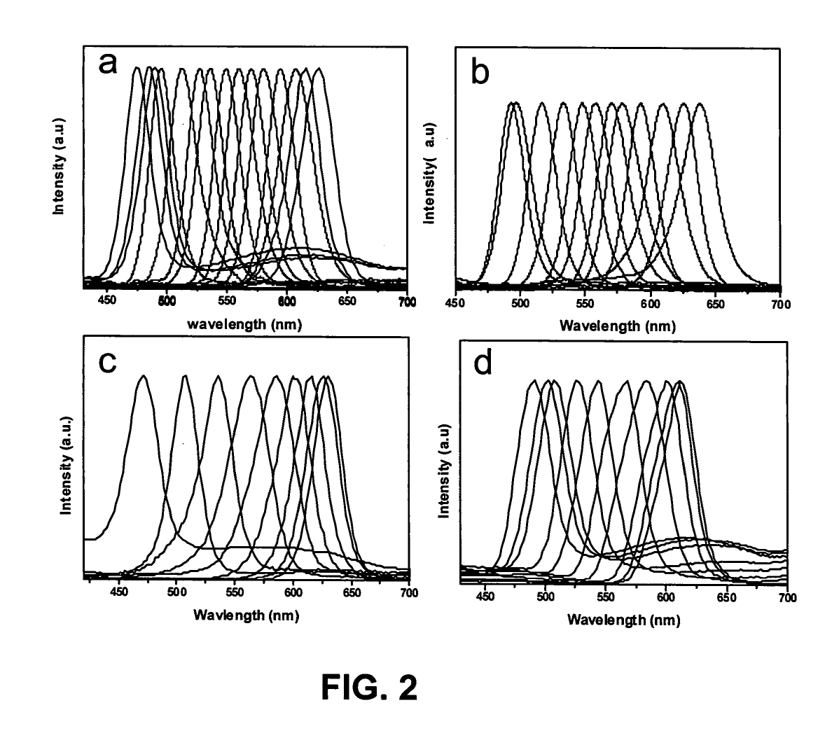

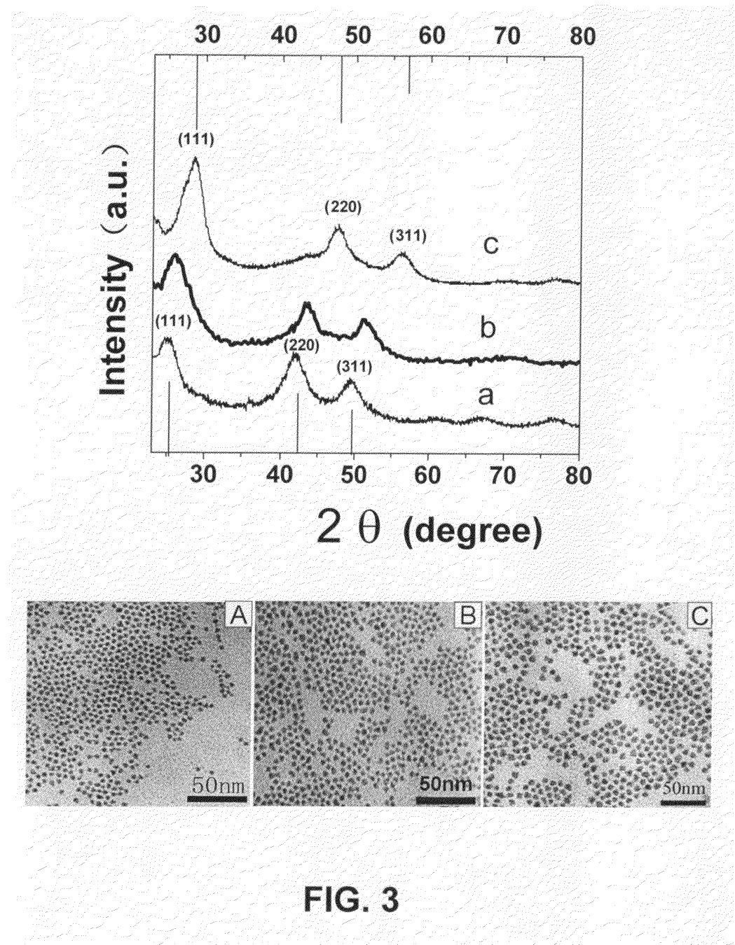

To adjust the reactivity and obtain different sizes of CdSe nanocrystals, most of the previously published methods put the focus on the use of different fatty acids, amines, phosphine oxides (such as TOPO), phosphonic acids (such as octadecylphosphonic acid), and the mixture of these common chemicals with certain compositions to prepare cadmium precursors; and just simply chose alkylphosphine (TOP or TBP) to make Se precursors. In the present invention, three kinds of phosphine-free Se precursors are prepared by mixing Se with ODA, OA in ODE or ODE itself respectively. These different kinds of Se precursors have been used to collect the information on the reactivity of CdSe nanocrystals and get optimized condition to synthesize different sizes of high quality CdSe nanocrystals. When Cd oleate is chosen as the Cd precursor, it is found that the highest quality CdSe nanocrystals are obtained by using Se-ODA-ODE precursor. Moreover, Cd stearate is also used as Cd precursor to react with Se-ODA-ODE for CdSe synthesis and some related result is shown in FIG. 2. In general, the reaction speed is relatively slow when Se-ODA-ODE is used as Se precursor. The whole reaction process is stable and ODA plays an important role to decrease the speed of nanocrysal formation. The quality of CdSe nanocrystals is able to be controlled in same good level in the whole reaction. When Se-OA-ODE is chosen as Se precursor, the reaction rate is much faster. FIGS. 2a and 2b show the series PL spectra when Se-ODA-ODE and Se-OA-ODE are chosen as precursors to synthesize CdSe nanocrystals respectively. The PL spectra covered from 459 to 625 nm when ODA is used to make Se precursor. The PL spectra covered from 493 nm to 640 nm are obtained when Se-OA-ODE precursor is used. The relationship between the reaction speeds and PL peak positions are shown in FIG. 3a in which it clearly shows the reaction speed is slower in the early stage with Se-ODA-ODE precursor than Se-OA-ODE or only Se in ODE precursors. ODA plays a role to slow down the reaction speed which makes the whole reaction easy to control, therefore, as-prepared CdSe nanocrystals in the whole reaction always kept good size distributions with strong PL emission. It may also affect the size distribution of nanocrystals and lead to wider FWHM.

B: Synthesis of CdSe/ZnS, CdSe/CdS, and CdSe/CdS/ZnS Core/Shell Nanocrystals.

CdSe/ZnS, CdSe/CdS, and CdSe/CdS/ZnS core-shell nanocrystals are prepared by a two-step procedure consisting of synthesis of CdSe core nanocrystal and growth of ZnS layers with or without CdS as the middle layers. The X-ray diffraction (XRD) patterns of the core and core/shell nanocrystals are shown in FIG. 3. CdSe nanocrystals with diameter of 3.1 nm are used as core to synthesize core-shell nanocrystals. For comparison, the standard powder diffraction patterns of zinc blende CdSe and ZnS bulk crystals are provided. Three broad diffraction peaks are observed to correspond to the (111), (220), and (311) planes of zinc blende phase CdSe, which is different from Se-TBP synthesized CdSe nanocrystals with wurtzite structure. XRD patterns shifted from a zinc blende CdSe-like one to a zinc blende ZnS-like one upon the increase of the shell thickness. The peak positions are located in the middle of pure CdSe and pure ZnS's positions after the growth of five ZnS monolayers. It shifted to ZnS diffraction patterns totally after the growth of nine ZnS monolayers. The same trend is observed in CdSe/CdS/ZnS too. For better comparison, TEM images for CdSe core and CdS/ZnS core-shell nanocrystals are shown in FIG. 3. After the growth of nine ZnS monolayers, the size is increased from 3.1±0.3 nm to 6.8±0.5 nm. Therefore, monodisperse CdSe/ZnS core-shell nanocrystals have been successfully prepared and the QYs of CdSe/ZnS nanocrystals exceed 80%.

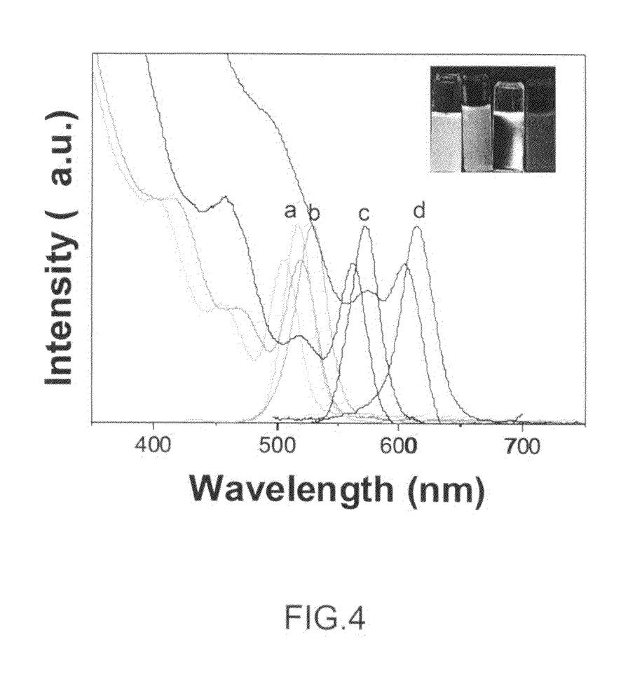

Different sizes of CdSe cores have been selected to synthesize CdSe/ZnS core-shell nanocrystals and they could cover the whole visible range. The absorption and PL spectra of several core-shell nanocrystals are shown in FIG. 4. The inset is the photos took under 365 nm UV lamp irradiation, very pure emitting colors have been observed. As large as 12 g of CdSe/ZnS core-shell nanocrystals are synthesized and the quality is at the same level as it did in the synthesis of ˜mg scale. Overall, the cost is much lower than the current widely used alkylphosphine related methods.

C: Synthesis of ZnSe Nanocrystals

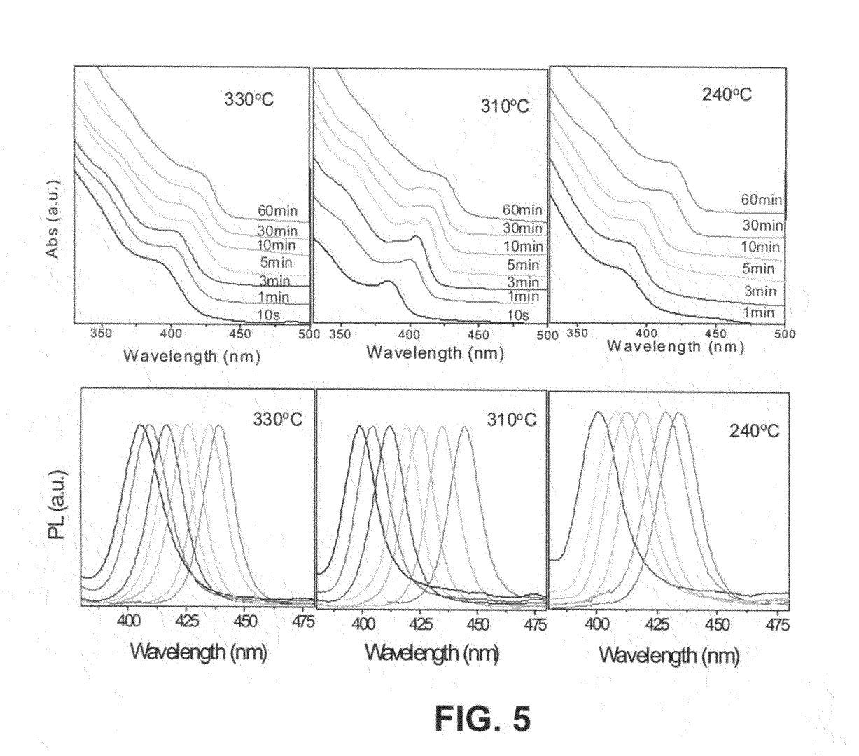

For the synthesis of ZnSe nanocrystals, we also used two approaches to do the injection: selenium precursor injection or zinc precursor injection. As reported before (Li L S, et al. Nano Lett. 4, 2261, (2004)), only selenium precursor injection method could synthesize high quality ZnSe nanocrystals with the use of phosphine-selenium precursor. Aliphatic amines have to be chosen as the reagents to activate the zinc carboxylate precursors too. But with the use of current phosphines-free selenium precursor, both selenium precursor injection and zinc precursor injection methods have been demonstrated to synthesize high quality monodisperse ZnSe successfully. Its PL covers the range from 405 to 445 nm, and the QY could reach between 20 to 40%. For the zinc precursor injection method, the first absorption peak is at 385 nm (FIG. 5) when the reaction lasted 10 s and the FWHM for PL is 17 nm. Absorption and PL are red-shift as the reaction continued and the FWHM decreased further and is between 14 and 17 nm in the whole reaction as the PL covering the range between 390 and 450 nm. If the injection temperature is increased to 330° C., the reaction went even faster, absorption peak shifted to 392 nm after 10 s. Because more amount of precursor is used to form nuclei in the early stage, its PL only reached 440 nm compare to 450 nm at the injection of 310° C. The FWHM is broad, but it is still controlled between 14 to 20 nm. As well known, saturated acid with short chain generally has more activity than it with long chain, such as decanoic acid (DA) is more active than oleic acid. Therefore, for further test whether high quality ZnSe could be synthesized at a lower temperature, oleic acid is replaced by decanoic acid to make Zn precursor. The promising results indicated highly monodisperse ZnSe still could be synthesized when the temperature is as low as 240° C. It is noticed that the reaction went slow in the early stage, absorption and PL are very weak when the reaction only lasted 10 s. Both absorption and PL turned strong after 1 min of the initial injection. The absorption peak turned sharper as the reaction lasted longer, the PL covered from 400 to 435 nm (FIG. 5).

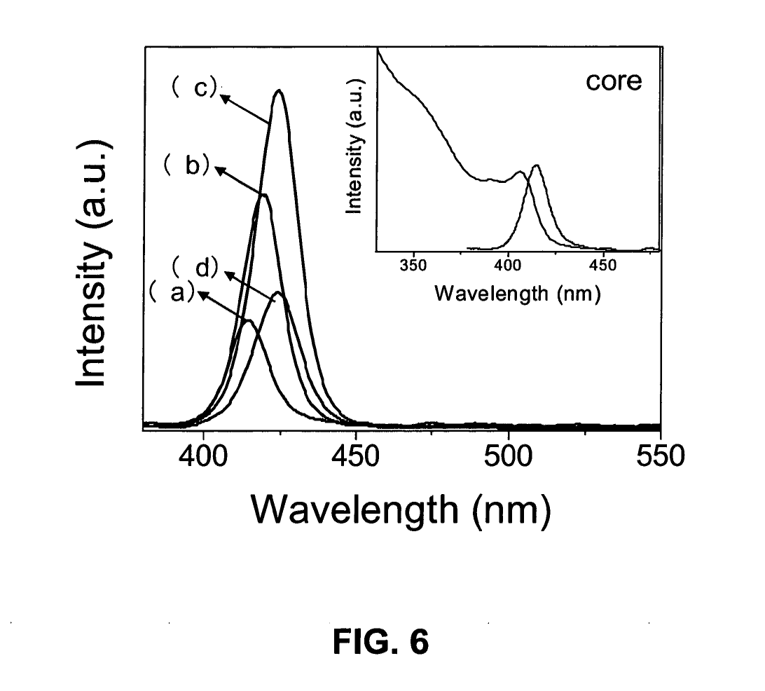

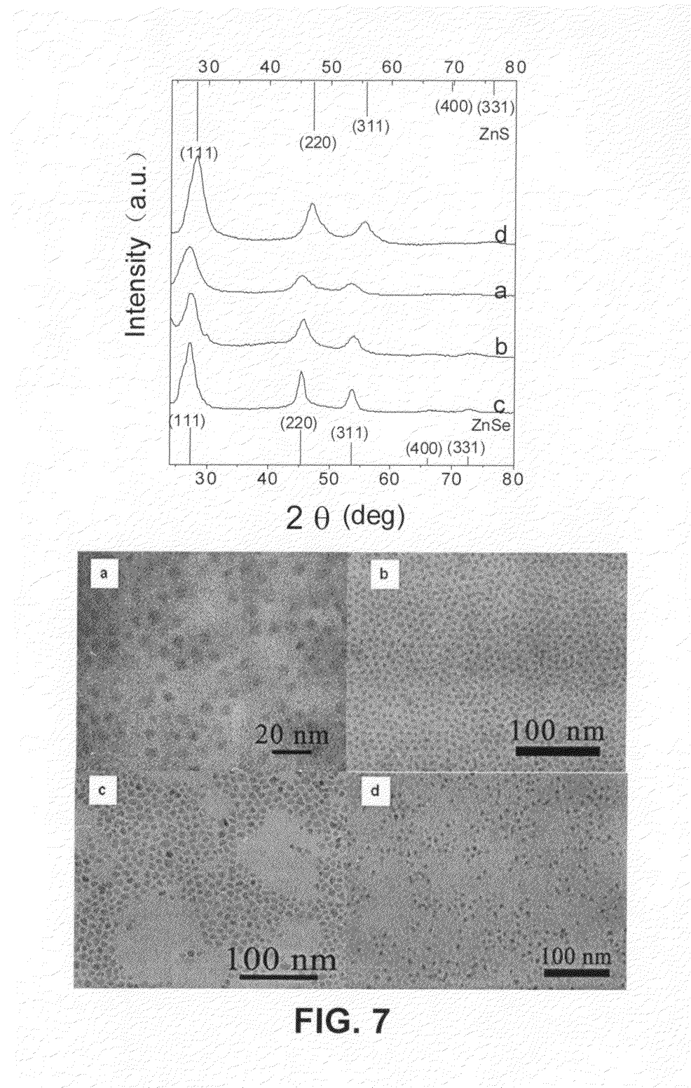

For the increase of PL stability and QY of ZnSe nanocrystals, ZnSe nanocrystals synthesized under 310° C. with the zinc precursor injection method have been used as core to synthesize ZnSe/ZnS core-shell nanocrystals. As shown in FIG. 6, its PL is centered at 414 nm. The highest PL intensity could be reached after two layers of ZnS overcoating, its QY of as-prepared core-shell nanocrystals could reach as high as 70%. But QY would drop if further ZnS layers have been overcoated, QY is only 38% after overcoating with three ZnS layers. To further characterize the structures of ZnSe and ZnSe/ZnS core-shell nanocrystals, their crystallographic properties are determined using powder X-ray diffraction (XRD) (FIG. 7). According to the X-ray powder diffraction pattern, the peak positions for the ZnSe nanocrystals are in agreement with bulk ZnSe in zinc-blende structure and ZnSe nanocrystals synthesized through phosphine-selenium precursor method. Three obvious diffraction peaks located at 27.4, 45.6, and 54.0 degrees are corresponded to the (111), (220), and (311) planes of zinc blende phase ZnSe. Also it is clear shown that XRD peaks went narrow along with the increase of ZnSe nanocrystals' sizes. An obviously peak shift to standard ZnS position has been observed when ZnS shells are growth on the ZnSe core and it is still kept zinc blende structure. As described above, typical ZnSe nanocrystals synthesized at 310° C. with the zinc precursor injection method have a standard deviation of about ±5% through TEM image analysis. The size of ZnSe nanocrystals with PL at 414 nm has an average size of 5 nm. As the increase of the ZnSe nanocrystal's size, PL showed a red shift. When PL reached 445 nm, an average size is counted around 9.6 nm.

D: Synthesis of Cu²⁺ and Mn²⁺ Doped ZnSe Nanocrystals

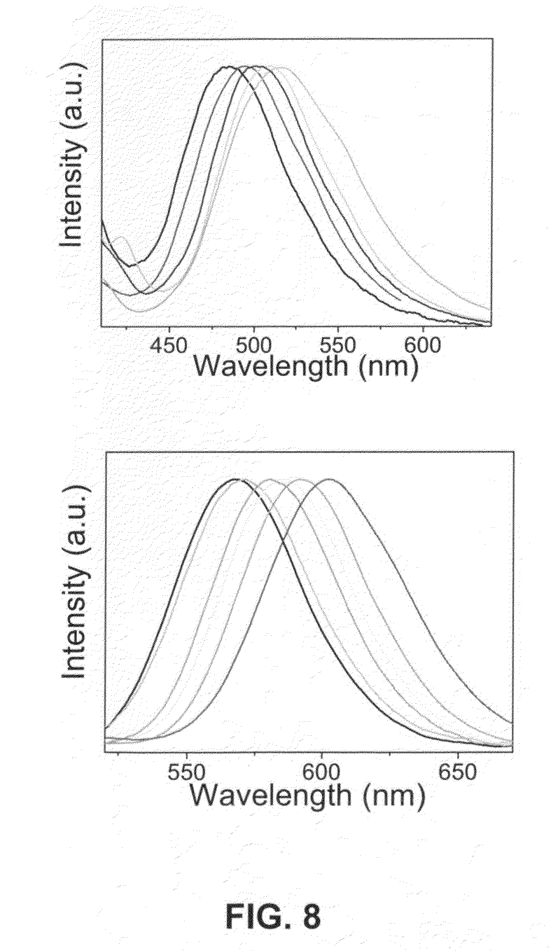

Furthermore, we tested to dope some ions into ZnSe nanocrystals for visible range emission based on this new established method. Cu²⁺ and Mn²⁺ have been selected here to generate emitting at green and orange range, respectively. For the synthesis of Cu²⁺ doped ZnSe, it is found the reactivity of ZnSe decided the difficulty of the doping process. If the size of ZnSe nanocrystals is very small (such as PL at 398 nm with average size at 2.9 nm), it had a high reactivity and very easy to absorb Cu²⁺ on its surface. Then, it would easy to overcoat ZnSe on the top and form Cu²⁺:ZnSe/ZnSe core/shell structures (FIG. 8). The experimental results indicated a promising result with Cu²⁺ doped on ZnSe when the temperature is set between 200 and 240° C. ZnSe's band gap emission would be replaced by Cu dopant's emission and covered the range between 480 nm and 520 nm. An average FWHM of PL is around 70 nm. When it is overcoated with certain thickness of ZnSe and ZnS, the QY could be increased to as high as 20%. For Mn²⁺ doped ZnSe nanocrystals, MnSe is first synthesized at high temperature (such as 300° C.). Then, Zn precursor is added slowly after certain time. The PL is controlled at around 570 nm and 600 nm when the addition of Zn precursor is happened after 30 min or 60 min of the beginning of the reaction. The surface layer of MnSe formed between MnSe and ZnSe may contribute to the emission. Its emission is covered from 570 nm to 610 nm with QY as high as 40% (FIG. 8).

E: Synthesis of Cu₂₋ₓSe and Cu₂₋ₓSe/SnSe Nanocrystals

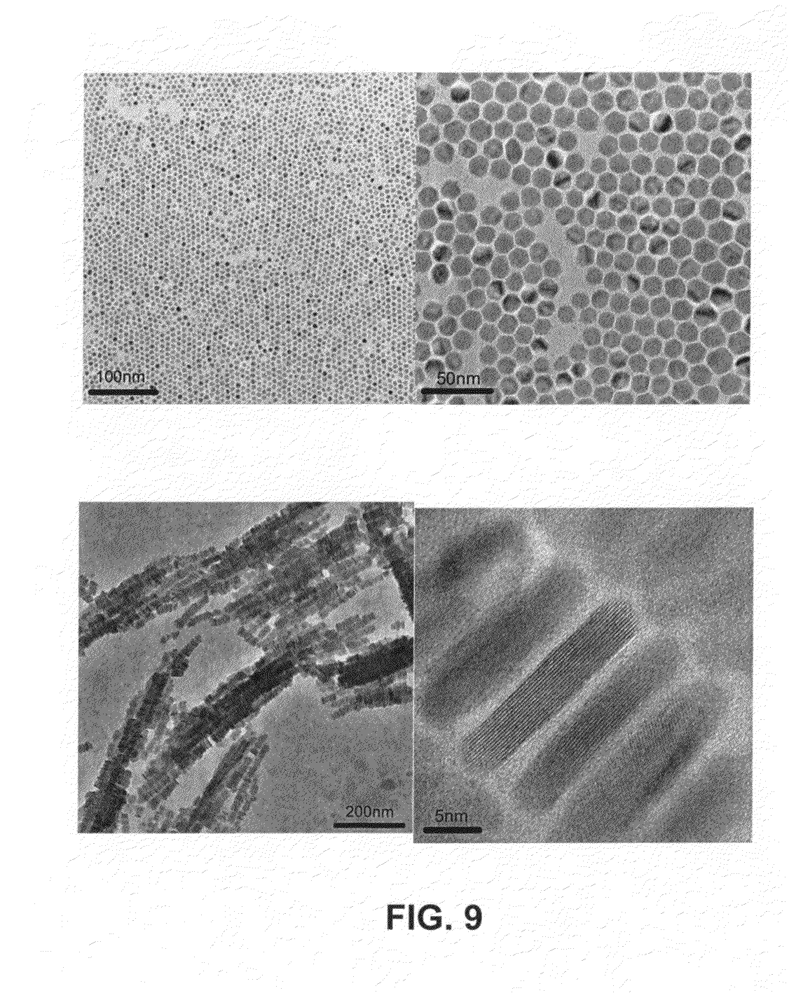

FIG. 9 shows TEM and HRTEM images of two different kinds of morphologies of Cu₂₋ₓSe nanocrystals formed without or with the participation of Sn(acac)₂Cl₂ in the reaction, respectively. Nearly monodisperse Cu₂₋ₓSe nanospheres are prepared with the absence of Sn(acac)₂Cl₂, while the shape of Cu₂₋ₓSe nanocrystals is totally different when Sn(acac)₂Cl₂ is introduced. The Cu₂₋ₓSe/SnSe nanocrystals have a strong self-assembling tendency, and at first glance, 1D superstructures are formed by the arrays of many nanorods. However, careful observation reveals that the building blocks of the 1D superstructures are in fact hexagonal nanoplates. The HRTEM image of the ordered hexagonal nanoplate arrays standing edge-on perpendicular to the substrate shows a lattice spacing of 0.68 nm, which is consistent with (111) plane d spacing of monoclinic primitive Cu₂₋ₓSe.

F: Synthesis of PbSe and PbTe Nanocrystals

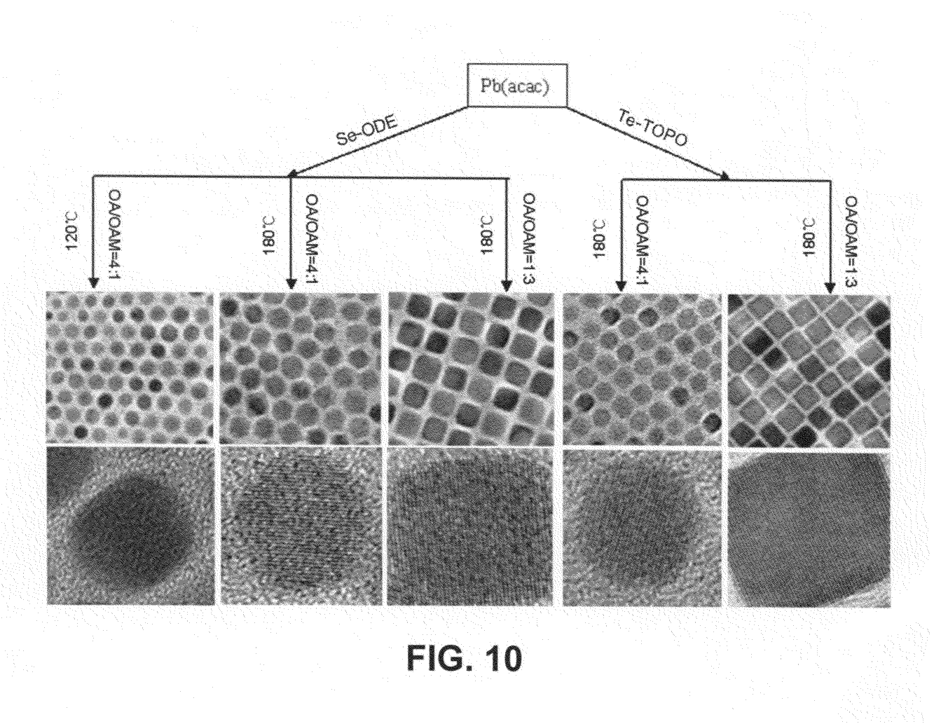

FIG. 10 shows PbSe and PbTe with different sizes and shapes obtained by changing the reaction temperature and the molar ratio between DA and OAM precursors. The rock salt structure of the PbSe and PbTe materials, which possess different surface energies in different directions, allow controlling the shape of the nanoparticles by increasing and/or decreasing the growth rate in different directions. When the ratio is 4:1 (DA:OAM), and the temperature is set at 120° C. a series of different size of PbSe are obtained, the biggest size is about 8 nm. But all the other parameters are kept the same, we observe highly spherical PbSe nanocrystals as large as 12 nm in diameter when only the reaction temperature is increased to 180° C. If we keep the temperature at 180° C., all the other parameters are kept the same except the ratio between DA and OAM is changed to 1:3, cube-shape morphology of PbSe nanocrystals are obtained as shown in FIG. 10. The cubic-like PbSe nanocrystals have an edge length of 14 nm. If Se precursor is replaced by Te-TOPO, highly spherical PbTe nanocrystals as large as 10 nm in diameter and cubic PbTe nanocrystals having a 16 nm edge length are obtained. Furthermore, FIG. 10 provides the HRTEM images on dot and cubic PbTe nanocrystal oriented along (100), respectively. All the PbSe and PbTe nanocrystals in HRTEM images have well-resolved lattice images, which imply good crystallinity.

G: Synthesis of Zn₁₋ₓCdₓSe (0<x<1) and Zn₁₋ₓCdₓSe Based Core/Shell Nanocrystals

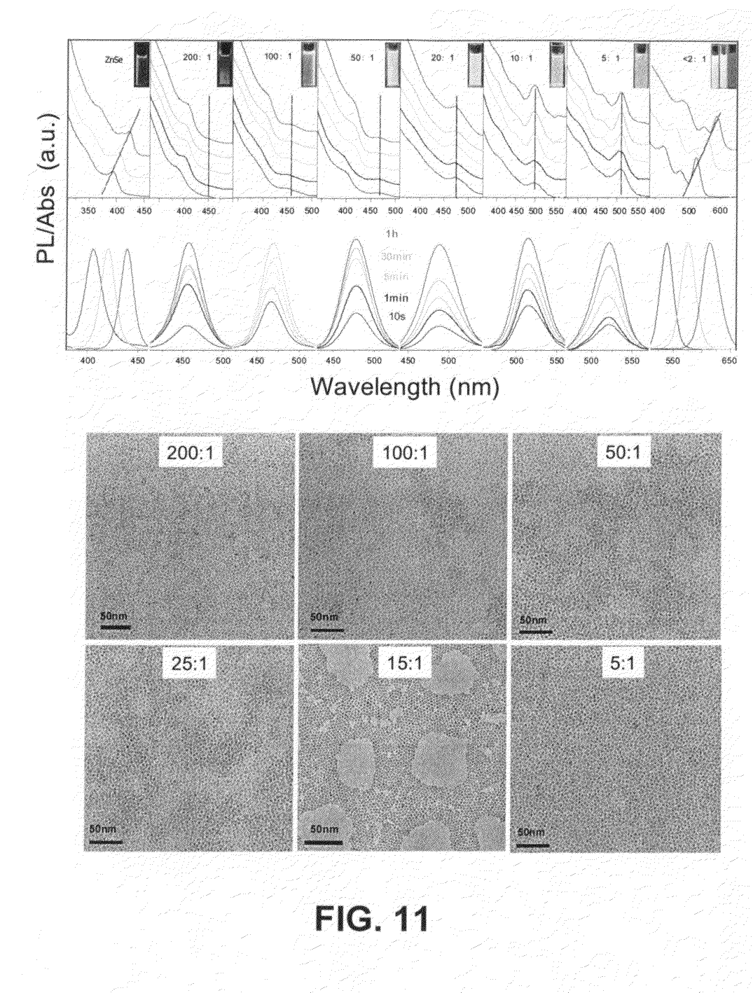

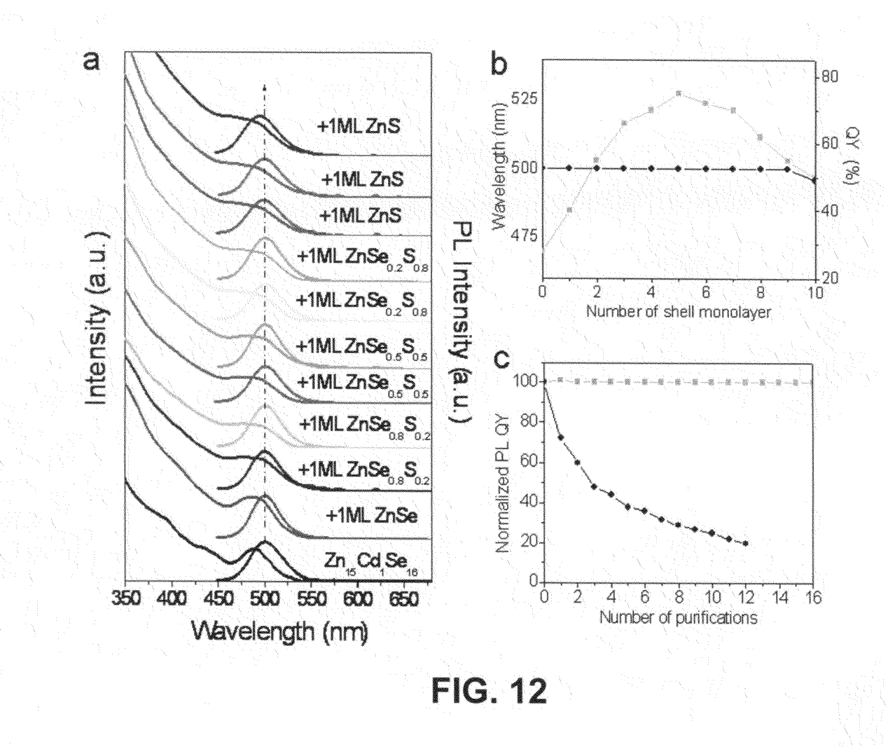

For the synthesis of alloyed Zn₁₋ₓCdₓSe nanocrystals through this phosphine-free synthesis method, selenium needs to be dissolved in ODE and formed an active complex as the precursor before the synthesis of nanocrystals. FIG. 11 shows the absorption and PL spectra of alloyed Zn₁₋ₓCdₓSe nanocrystals with different molar ratios of Zn and Cd. The injection and reaction temperatures are set to 280 and 260° C., respectively. Without Cd, the first excitonic absorption peak position of ZnSe nanocrystals exhibit a red shift as the increase of reaction time. Its PL covers the range from 400 to 450 nm and the QY can reach 60%. When the molar ratio between Zn and Cd is in the range of 200:1 to 100:1, absorption peak is more ZnSe-liked feature and only little red shift located at 400 nm is observed in the entire reaction. As the content of Cd increases, the absorption peak shifts to CdSe-liked feature. When the molar ratio of Zn and Cd is 50:1, an obvious first excitonic absorption peak located at 470 nm is observed. Surprisely, the first excitonic absorption peak position of Zn₁₋ₓCdₓSe nanocrystals can be fixed and do not show any red or blue shift in the entire reaction process. The emission peak position is only determined by the ratio between Zn and Cd and there is no emission peak shift at different reaction times when the injection temperature is set at 280° C. and higher. Until this ratio is set below 2:1 in the synthesis process, the first excitonic absorption peak position begins to exhibit red-shift again. The FWHM is well controlled between 28 to 45 nm. FIG. 12 shows the UV-vis and PL spectra of the core-shell nanocrystals from a typical reaction. The result indicated that such ZnSe/ZnSeₓS₁₋ₓ layers indeed increased both QY and stability of alloyed Zn₁₋ₓCdₓSe core-shell nanocrystals. When ZnSe/ZnSeₓS₁₋ₓ/ZnS is chosen as the overcoating mutlishell, the QYs of the as-prepared core-shell alloyed Zn₁₋ₓCdₓSe nanocrystals with blue and green emissions reached 50 to 75% almost without any PL peak shift (FIGS. 12a, 12b and 12c). We also observed that, upon precipitation from growth solution and re-dissolution in hexane, the alloyed Zn₁₋ₓCdₓSe core-shell nanocrystals are insensitive to changes in ligand loss. In contrast, QYs for alloyed Zn₁₋ₓCdₓSe core dropped by approximately 20% (FIG. 12c).

H: Synthesis of CdTe and CdTeₓSe₁₋ₓ Nanocrystals

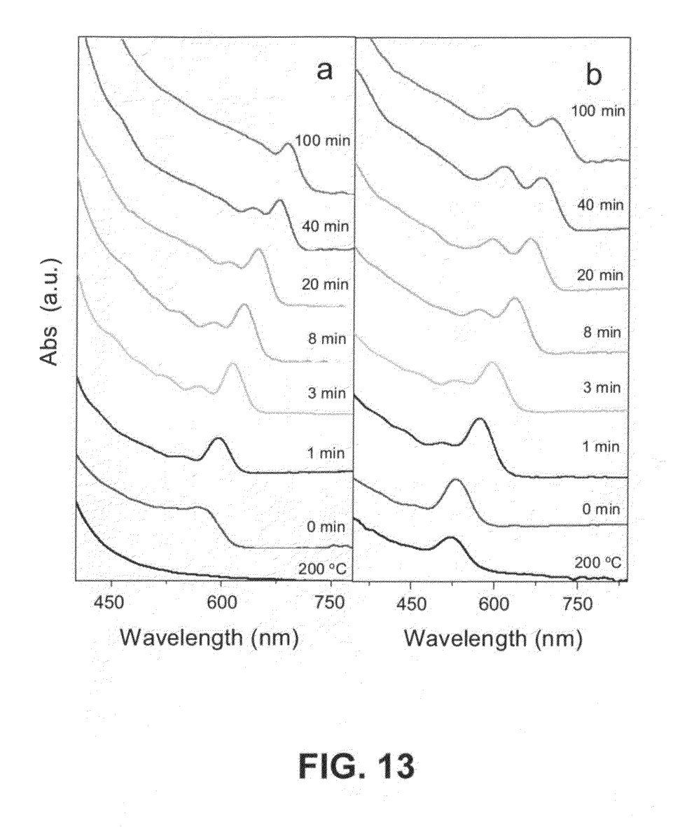

For making high-quality metal-telluride nanocrystals, paraffin oil is chosen as the reaction solvent and TBP/TOP is replaced by TOPO or Di-noctylphosphine oxide (DOPO) as the solvent of Te precursor. Because of the high chemical stability of TOPO, this new synthesis does not require the use of a glove box. In a typical II-VI nanocrystal synthesis, Te-TOPO or Te-DOPO (0.2 mmol), cadmium acetylacetonates (0.2 mmol), and decanoic acid (0.8 mmol) are added to a three-neck flask with paraffin oil (5 mL). The resulting mixture is heated, with stirring, to 220° C. at a rate of 20° C. min⁻¹. After the temperature reached 220° C., serial aliquots are removed for kinetic studies. No nucleation occurred until 220° C. for CdTe nanocrystals (FIG. 13a), but small CdTeₓSe₁₋ₓ nanocrystals appeared right after the temperature reached 200° C. (FIG. 13b). It is noticed that in the early stage of those reactions, the PL QY of CdTe and CdTeₓSe₁₋ₓ nanocrystals are very weak when the reaction only lasted 30 s. Both absorption and PL turned strong after 1 min. The emission peak positions of CdTe and CdTeₓSe₁₋ₓ nanocrystals cover the range between 590-710 nm and 573-686 nm, respectively (FIG. 13). The PL FWHM is between 30-36 nm and 35-40 nm for CdTe and CdTeₓSe₁₋ₓ nanocrystals, respectively. All the FWHM of those nanocrystals have a decrease process which indicated at the early age of the nanocrystals appeared, they have a broader distribution, as the nanocrystals grew, their size distribution continued to decrease. As the growth time went on, the size distribution of nanocrystals further narrowed with particle growth until a final size is reached. With further annealing at the reaction temperature, the narrow size distribution of the resulting particles is maintained, at least for overnight. Neither Ostwald ripening nor secondary nucleation is detected during the synthesis. These nanocrystals have a typical PL QY of about 50%, and have up to four absorption peaks which also indicating their narrow size distribution.

TEM images of three different sized nanocrystals synthesized with a non-injection synthesis approach in FIG. 13. TEM studies show that these nanocrystals have a typical size distribution of approximately 5% and the narrow size distribution of the as-synthesized CdTe and CdTeₓSe₁₋ₓ nanocrystals remains high even at large nanocrystal sizes. Such monodispersity of as-prepared CdTe and CdTeₓSe₁₋ₓ nanocrystals could achieve the TOP/TBP methods of synthesis reported earlier.

I: Synthesis of CuInSe₂ and CuInSe₂/ZnS Nanocrystals

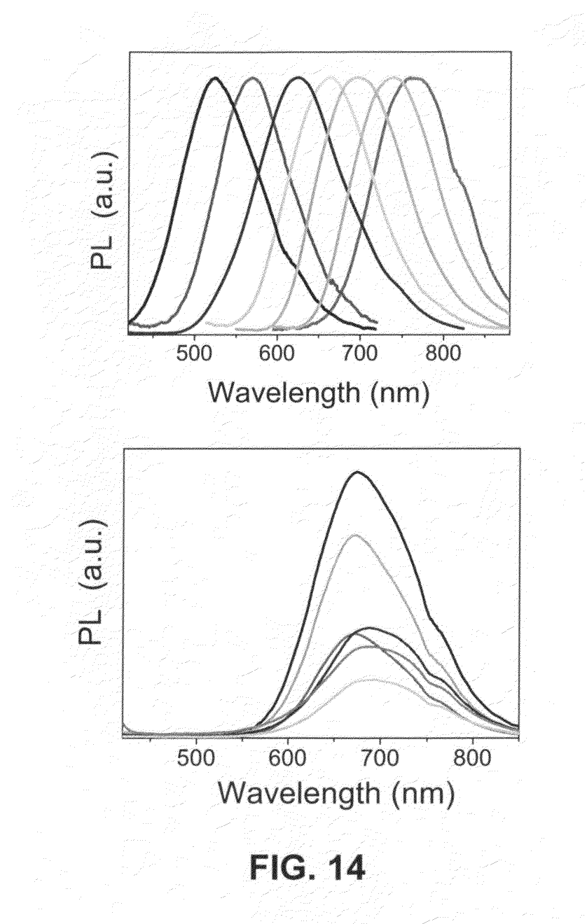

FIG. 14 shows PL spectrum of CuInSe₂ nanocrystals. The PL spectrum exhibits an emission peak covers from 520-770 nm and is consistent with the expected quantum confinement effect. Current researches showed that the optical properties of CuInSe₂ nanocrystals are influenced by at least three factors, such as size and shape, surface states, and compositions. A proven strategy for reducing the surface defects is to grow a shell of higher band gap semiconductor material onto the core nanocrystals. To determine the effects of surface defects on the PL emission, the shell-coating strategy is introduced. After coating ZnS shells on the as-prepared CuInSe₂ nanocrystals, the PL peak bule-shifted continuously from 690 to 670 nm and the PL intensity increased nearly five times, but the FWHM showed no change (FIG. 14). These phenomena imply that surface defects do have played a role in the effect of PL emission.

J: Preparation of Water-Soluble CdSe/ZnS Nanocrystals

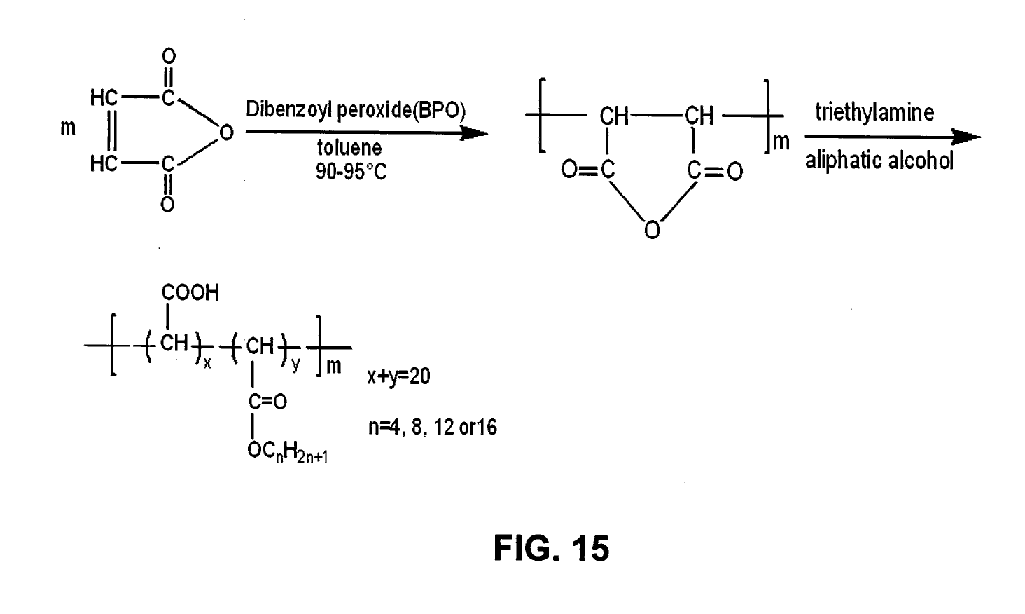

FIG. 15 illustrated the procedure for synthesizing amphiphilic oligomer (polymaleic acid aliphatic alcohol ester, PMAA) in acetone through the reaction between polymaleic anhydride (PMA) and aliphatic alcohol. It should be noted that anhydrous conditions is needed for the synthesis of PMA and PMAA. The molecular weight of the as-prepared PMA is approximate 1000, which makes the unit number of maleic anhydride in every PMA molecular chain ˜10. The number of the free COOH groups in every PMAA molecular chain can also be confirmed by calculating the grafting ration of the PMA that is conducted by acid-base titrations. For polymaleic acid n-hexadecanol ester (PMAH), the number of COOH groups in each amphiphilic chain range from 12 to 18 according to the maletic anhydride (MA) monomer/hexadecanol molar ratio. So the number of surface functional groups (—COOH) per CdSe/ZnS particle could be controlled to attach biomolecules of a desired quantity according to the actual need. The PMAA oligomer synthesized by this method is available at low price and more economical than some surfactants and specially synthesized polymers, which makes the phase transfer method suitable for large-scale production and application.

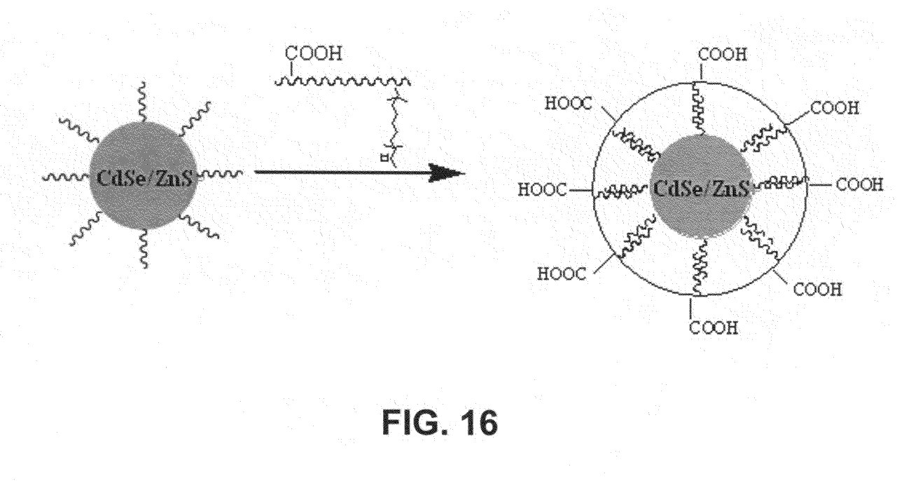

The as-prepared water-soluble CdSe/ZnS PL microspheres are illustrated in FIG. 16. Our primary goal is to prepare water-soluble microspheres in which hydrophobic CdSe/ZnS nanocrystals are incorporated into the microsphere containers. First, the hydrophobic purified CdSe/ZnS nanocrystals and amphiphilic surfactant are dispersed in chloroform phase and water phase (V_{water}>V_{chloroform}), respectively. Then, a stable emulsion system (O/W) is formed after mixing water (containing PMAA) and chloroform (containing CdSe/ZnS nanocrystals) solution under the magnetic stirring, in which thermodynamically stable micelles consisting of CdSe/ZnS nanocrystals are steadily dispersed in the water phase with the help of amphiphilic surfactant (PMAA). While stirring vigorously, the sealer is then removed to evaporate the oil phase (chloroform). Between the alkyl chains of amphiphilic oligomer and the hydrophobic coating of CdSe/ZnS nanocrystals, there exist van der Waals interactions, which play a significant role in stabilizing CdSe/ZnS nanocrystals in aqueous solutions. Through the evaporation of chloroform under vigorous stirring (phase transfer), the hydrophobic nanocrystals and PMAH bond to each other by an interfacial process driven by the multivalent hydrophobic van der Waals interactions between the primary alkane of the stabilizing ligand and the secondary alkane of the amphiphilic oligomer, resulting in PMAA stabilized CdSe/ZnS PL microspheres. Controlled synthesis of different sizes of PL microspheres can be conducted by simple changing the initial oligomer concentration and/or water/chloroform volume ratio. When the oligomer/nanocrystals molar ratio exceeded 200:1, only oligomer-coated monodisperse CdSe/ZnS nanocrystals without any aggregation were obtained. If the molar ratio ranged from 20:1 to 120:1, size-tunable PL microspheres could be obtained with the size range from 151 to 50 nm. We have applied the same strategy to transfer other organic solvent-synthesized nanocrystals into water. For example, monodisperse Au or Ag nanocrystals and magnetic iron oxide (Fe₃O₄) nanocrystals are successfully transferred into water.

### EXAMPLES

Stock Solutions for Cd, Zn, Se, Te, Pb, Cu, In, Mn, and Sn Precursors.

Stock solution of Se-A-1: Se (2 mmol) and 20 mL of ODE are loaded in a 50 mL three-neck flask and degassed, the mixture is heated to 100° C. then maintained for 20 min and subsequently heated to 220° C. then maintained for 3 h. Stock solution of Se-A-2: SeO₂ (2 mmol) and 20 mL of ODE are loaded in a 50 mL three-neck flask and degassed, the mixture is heated to 100° C. and then maintained for 20 min, subsequently heated to 220° C. then maintained for 3 h.

Stock solution of Se-B: Se (2 mmol), ODA (6 mmol), and 20 mL of ODE are loaded in a 50 mL three-neck flask and degassed, the mixture is heated to 100° C. then maintained for 20 min, subsequently heated to 220° C. then maintained for 3 h.

Stock solution of Se-C: SeO₂ (2 mmol), ODA (6 mmol), and 20 mL of ODE are loaded in a 50 mL three-neck flask and degassed, the mixture is heated to 100° C. then maintained for 20 min, subsequently heated to 220° C. then maintained for 3 h.

Stock solution of Se-D: Se (2 mmol), OA (6 mmol), and 18 mL of ODE are loaded in a 50 mL three-neck flask and degassed, the mixture is heated to 100° C. then maintained for 20 min, subsequently heated to 220° C. then maintained for 3 h.

Stock solution of Se-E: SeO₂ (2 mmol), OA (6 mmol), and 18 mL of ODE are loaded in a 50 mL three-neck flask and degassed, the mixture is heated to 100° C. then maintained for 20 min, subsequently heated to 220° C. then maintained for 3 h.

Stock solution of Te precursor: Te or TeO₂ (4 mmol) and TOPO or DOPO (40 g) are loaded in a 100 mL three-neck flask and degassed for 30 min, the mixture is heated to 350° C. under nitrogen then maintained for 30 min, subsequently heated to 400° C. then maintained for 10 h. During this time, the color of the mixture changed from dark to light yellow.

Solution of Cd precursor: The molar concentration of the Cd precursor is 0.1 mmol/mL. CdO (0.1284 g, 1 mmol), OA (0.846 g, 3 mmol), and ODE (9.05 mL) are loaded into a 25 mL three-neck flask, and heated to 240° C. under a nitrogen flow to obtain a clear colorless Cd precursor solution.

Solution for Zn-OA precursor: A mixture (20 mL in total) of ZnO (0.16274 g, 2 mmol), decanoic acid (8 mmol), and 18.5 mL paraffin oil is loaded in a 50 mL three-neck flask and heated to 300° C. under nitrogen to obtain a colorless clear solution.

Solution for Zn-DA precursor: A mixture (20 mL in total) of ZnO (0.16274 g, 2 mmol), oleic acid (8 mmol), and 17.5 mL paraffin oil is loaded in a 50 mL three-neck flask and heated to 300° C. under nitrogen to obtain a colorless clear solution.

Solution for Zn-ODPA precursor: A mixture (20 mL in total) of ZnO (0.16274 g, 2 mmol), octadecylphosphonic acid (ODPA) (4 mmol), and 17.5 mL paraffin oil is loaded in a 50 mL three-neck flask and heated to 310° C. under nitrogen to obtain a colorless clear solution.

Stock solutions for shell growth: The zinc precursor solution (0.1 M) is prepared by heating a mixture of ZnO (0.1628 g, 2 mmol), oleic acid (5.64 g, 16 mmol), and ODE (13.7 mL) to 310° C. The cadmium precursor solution (0.1 M) is prepared by heating a mixture of CdO (0.256 g, 2 mmol), oleic acid (5.64 g, 16 mmol), and ODE (13.7 mL) to 240° C. The sulfur precursor solution (0.1 M) is prepared by heating a mixture of sulfur (0.064 g, 2 mmol) and ODE (20 mL) to 150° C. All the above stock solutions are prepared under nitrogen flow.

Synthesis of lead acetylacetonates [Pb(acac)₂], copper acetylacetonates [Cu(acac)₂], indium acetylacetonates [In(acac)₃] and cadmium acetylacetonates [Cd(acac)₂]: In a typical synthesis, 20 mmol PbCl₂ is dissolved in 10 mL deionized water. Under magnetic stirring, 2,4-pentanedione (5 mL, 50 mmol) is added and kept stirring for 15 minutes. Pb(acac)₂ is precipitated after appropriate amount of triethylamine is added in the solution. Then, Pb(acac)₂ is washed for several times by ethanol and water and finally is dried in vacuum at 50° C. for further use. The synthesis of Cu(acac)₂, In(acac)₃, Cd(acac)₂ are similar to that of Pb(acac)₂.

Synthesis of copper stearate (CuSt₂) and manganese stearate (MnSt₂): In a typical synthesis, sodium stearate (20 mmol) is dissolved in 80 g of methanol and heated to 50-60° C. until it became a clear solution, CuCl₂ or MnCl₂ solution of 10 mmol in 10 g methanol is added dropwise with vigorous stirring and precipitation of CuSt₂ or MnSt₂ slowly flocculated. The precipitate is washed repeatedly with methanol three times and then dried under vacuum.

Synthesis of tin (IV) bis(acetylacetonate) bichloride [Sn(acac)₂Cl₂]: 20 mmol SnCl₄ is dissolved in 10 mL deionized water. Under magnetic stirring, 2,4-pentanedione (5 mL, 50 mmol) is added and kept stirring for 15 minutes. Sn(acac)₂Cl₂ is precipitated after appropriate amount of triethylamine is added in the solution. Then Sn(acac)₂Cl₂ is washed for several times by ethanol and water, it is dried in vacuum at 50° C. for further use.

### Example 1

### CdSe with Cd Injection, Se-ODE Precursor

A mixture 2 mL stock solution of Se-A-1 and 4 mL ODE is loaded in a 25 mL three-neck flask and heated to 280° C. under nitrogen flow, 2 mL solution of Cd precursor is injected into the flask. The color of the reaction solution turned into light orange right after the injection, then subsequently changed to orange, light red, red, and dark red as the increase of reaction time. PLs spanning most of the visible spectra from 470 nm to 650 nm are obtained. The resulting CdSe nanocrystals could be dissolved in organic solvents like chloroform, hexanes, and toluene.

### Example 2

### CdSe with Se Injection, Se-ODE Precursor

A mixture (4 g in total) of CdO (0.0128 g, 0.1 mmol), oleic acid (0.3 mmol), and ODE is loaded in a 25 mL three-neck flask and heated to 240° C. under nitrogen flow to obtain a clear colorless solution. When it is heated to 280° C., 2 mL (0.2 mmol) Se-B stock solution is injected into the flask. The color of the reaction solution turned into light orange right after the injection, then subsequently changed to orange, light red, red, and dark red as the increase of reaction time. PLs spanning most of the visible spectra from 470 nm to 650 nm are obtained. The resulting CdSe nanocrystals could be dissolved in organic solvents like chloroform, hexanes, and toluene.

### Example 3

### CdSe with Cd Injection, Se-ODA-ODE Precursor

A mixture (4 g in total) of CdO (0.0128 g, 0.1 mmol), oleic acid (0.3 mmol), and ODE is loaded in a 25 mL three-neck flask and heated to 240° C. under nitrogen flow to obtain a clear colorless solution. When it is heated to 280° C., 2 mL (0.2 mmol) Se-C stock solution is injected into the flask. The color of the reaction solution turned into light orange right after the injection, then subsequently changed to orange, light red, red, and dark red as the increase of reaction time.

### Example 4

### CdSe with Cd Injection, Se-OA-ODE Precursor

A mixture (4 g in total) of CdO (0.0128 g, 0.1 mmol), oleic acid (0.3 mmol), and ODE is loaded in a 25 mL three-neck flask and heated to 240° C. under nitrogen flow to obtain a clear colorless solution. When it is heated to 280° C., 2 mL (0.2 mmol) Se-D stock solution is injected into the flask. The color of the reaction solution turned into light orange right after the injection, then subsequently changed to orange, light red, red, and dark red as the increase of reaction time.

### Example 5

### CdSe with Cd Injection, SeO₂-ODE Precursor

A mixture (4 g in total) of CdO (0.0128 g, 0.1 mmol), oleic acid (0.3 mmol), and ODE is loaded in a 25 mL three-neck flask and heated to 240° C. under nitrogen flow to obtain a clear colorless solution. When it is heated to 280° C., 2 mL (0.2 mmol) Se-E stock solution is injected into the flask. The color of the reaction solution turned into light orange right after the injection, then subsequently changed to orange, light red, red, and dark red as the increase of reaction time.

### Example 6

### Large Scale Synthesis of CdSe Nanocrystals with Cd Injection, Se-ODE Precursor

A mixture 100 mL stock solution of Se-A-1 and 100 mL ODE is loaded in a 500 mL three-neck flask and heated to 280° C. under nitrogen flow, 100 mL solution of Cd precursor is injected into the flask. Then it is set to 250° C. for reaction. The resulting CdSe nanocrystals could be dissolved in organic solvents like chloroform, hexanes, and toluene.

### Example 7

### CdSe/ZnS Core-Shell Nanocrystals

Nearly monodisperse CdSe nanocrystals ranging from 1.8 nm to 5.5 nm in diameter are synthesized and purified, respectively. First, such as-prepared CdSe nanocrystals are purified by repeated precipitation with methanol and redispersion in hexanes several times. By choosing different sizes of CdSe nanocrystals as core, core/shell nanocrystals with emitting color from green to red have been synthesized. A typical synthesis is performed as follows: 3 mL of ODE and 1 g of ODA are loaded into a 50 mL reaction flask, the purified CdSe nanocrystals in hexanes (2.8 nm in diameter, 2.7×10⁻⁷ mol) are added, and the system is kept at 100° C. under nitrogen flow for 30 min to remove hexanes with low vapor pressure. Subsequently, the solution is heated to 160° C. for the shell growth. First, 0.52 mL of the Zn and S solutions for the first shell layer are slowly dropped into the solution and the temperature is slowly raised to ˜180° C. in ˜10 min; next, 0.77 mL of each shell stock solution for the second layer is slowly dropped into the solution and the temperature is slowly raised to ˜200° C. in ˜10 min; then 1.1 mL and 1.45 mL of each shell stock solution for the third and fourth layers is slowly dropped into the solution and the temperature is slowly raised to ˜220° C. and 240° C. in ˜10 min, respectively; finally 2.0 mL of each shell stock solution for the fifth layer is slowly dropped into the solution and kept the temperature at 240° C. for 30 min. For thick shell growth, more Zn and S solutions are added. This adjustment with slow temperature increase not only enhanced the core-shell nanocrystal's PL QY, but also improved their crystallinity. With a period of 10 min between each addition, the UV-vis and PL spectra showed no further changes. For purification, 10 mL of hexanes is added and the unreacted compounds and byproducts are removed by successive methanol extraction (at least three times).

### Example 8

### CdSe/CdS/ZnS Core-Shell Nanocrystals

For the synthesis of CdSe/CdS core-shell nanocrystals, Cd-OA (0.1 M) has been used as the precursor to replace Zn-OA (0.1 M) and all the other treatments are the same as the synthesis of CdSe/ZnS core-shell nanocrystals in EXAMPLE 7. For the synthesis of CdSe/CdS/ZnS core-shell nanocrystals, Cd—OA precursor is used for the growth of first 2 to 3 layers CdS layers and other steps are kept the same as in EXAMPLE 7.

### Example 9

### ZnSe with Zn Injection, Se-ODE Precursor

Zinc precursor injection at 330° C.: 2 mL (0.2 mmol) Se-A-1 precursor and 4 g paraffin oil is heated to 330° C. under nitrogen flow in a 25 mL flask. Next, 2 mL (0.2 mmol) Zn-OA precursor solution is injected and temperature is lower to 300° C. for nanocrystal growth. PL spectra covered from 400 nm to 440 nm.

Zinc precursor injection at 310° C.: 2 mL (0.2 mmol) Se-A-1 precursor and 4 g paraffin oil is heated to 310° C. under nitrogen gas flow in a 25 mL flask. Next, 2 mL (0.2 mmol) Zn-OA precursor solution is injected and temperature is lower to 280° C. for nanocrystal growth. PL spectra covered from 390 nm to 450 nm.

Zinc precursor injection at 240° C.: 2 mL (0.2 mmol) Se-A-1 precursor and 4 g paraffin oil is heated to 240° C. under nitrogen gas flow in a 25 mL flask. Next, 2 mL (0.2 mmol) Zn-DA Precursor solution is injected and temperature is lower to 220° C. for nanocrystal growth. PL spectra from 400 nm to 435 nm are obtained.

### Example 10

### ZnSe with Se Injection, Se-ODE Precursor

1 mL (0.1 mmol) Zn precursor and 4 g paraffin oil in 25 mL flask is heated to 330° C. under nitrogen flow. Next, 2 mL (0.2 mmol) stock solution Se-A-1 is injected into the above flask and temperature is lower to 300° C. for nanocrystal growth. PL spectra are covered from 400 nm to 450 nm.

### Example 11

### ZnSe with Zn Injection, SeO₂—ODE Precursor

2 mL (0.2 mmol) Se-A-2 precursor and 4 g paraffin oil is heated to 330° C. under nitrogen flow in a 25 mL flask. Next, 2 mL (0.2 mmol) Zn-OA precursor solution is injected and temperature is lower to 300° C. for nanocrystal growth.

### Example 12

### ZnSe with Zn Injection, Se-ODE Precursor, Zn-DA

2 mL (0.2 mmol) Se-A-1 precursor and 4 g paraffin oil is heated to 330° C. under nitrogen flow in a 25 mL flask. Next, 2 mL (0.2 mmol) Zn-DA precursor solution is injected and temperature is lower to 300° C. for nanocrystal growth.

### Example 13

### ZnSe with Zn Injection, SeO₂—ODE Precursor, Zn-ODPA

2 mL (0.2 mmol) Se-A-2 precursor and 4 g paraffin oil is heated to 330° C. under nitrogen flow in a 25 mL flask. Next, 2 mL (0.2 mmol) Zn-ODPA precursor solution is injected and temperature is lower to 300° C. for nanocrystal growth. PL spectra covered from 400 nm to 440 nm.

### Example 14

### ZnSe/ZnS Core-Shell Nanocrystals

The ZnSe nanocrystals in hexanes (4.0 nm in diameter, 3×10⁻⁷ mol) are added, and the system is kept at 100° C. under N₂-flow for 30 min to remove the hexanes and other undesired materials of low vapor pressure. Subsequently, the solution is heated up to 240° C. under N₂-flow where the shell growth is performed as EXAMPLE 7. We found that a period of 10 min between each addition is sufficient for the reaction to be completed, because the UV-vis and PL-spectra showed no further changes after this period of time. At last, the optical property is better after reflux at 200° C. for about one hour, i.e. narrow PL FWHM at room temperature. The PL QYs of nanocrystals exceeds 70% after refluxing. For purification, 10 mL of hexanes is added and the unreacted compounds and by products are removed by successive methanol extraction (at least three times).

### Example 15

### Cu Doped ZnSe

Host ZnSe nanocrystals are synthesized according to the zinc precursor injection method reported in EXAMPLE 10. After a desired size of ZnSe is reached (such as PL at 400 nm), the temperature of the reaction mixture is cooled to 60° C. Then 5 mL Se precursor is added and the temperature is increased to 180° C., then 0.5 mL of CuSt₂ in paraffin oil (0.001 M) is added dropwise. As the temperature increased to 240° C., a blue-green emission is observed. Once the desired emission is reached, an extra amount of Zn-OA precursor is added and the temperature is increased to 260° C. for annealing.

### Example 16

### Mn Doped ZnSe

MnSt₂ (0.02 g, 0.032 mmol), 0.02 g ODA, and 12 g paraffin oil are loaded in a 50 mL three-neck flask, degassed by purging argon and heated to 300° C. MnSt₂ started to dissolve at about 100° C. and a clear solution is obtained at 250° C. Then, 4 mL (0.1 M) Se-A-1 solution is injected swiftly into the above reaction mixture at 300° C. The color of the resulting solution turned slightly yellowish but it intensified as the reaction progressed. After 30-120 min at 280° C., a solution of 0.4 mL zinc-DA precursor is injected. The reaction mixture is cooled to 240° C. and another 4 mL zinc-DA precursor is added dropwise.

### Example 17

### Cu Doped ZnSe/ZnS

4 mL of ODE and 0.4 g of ODA are loaded into a 50 mL reaction vessel. The Cu doped ZnSe nanocrystals in hexanes (5.0 nm in diameter, 3.2×10⁻⁷ mol) are added, and the system is kept at 100° C. under N₂-flow for 30 min to remove the hexanes and other undesired materials of low vapor pressure. Subsequently, the solution is heated up to 240° C. under N₂-flow where the shell growth is performed. The amounts of the Zn and S injection solutions are added as EXAMPLE 7. After that, Cu:ZnSe/ZnS core-shell nanocrystals are obtained.

### Example 18

### Mn Doped ZnSe/ZnS

4 mL of ODE and 0.4 g of ODA are loaded into a 50 mL reaction vessel. The Mn doped ZnSe nanocrystals in hexanes (6.2 nm in diameter, 2×10⁻⁷ mol) are added, and the system is kept at 100° C. under N₂-flow for 30 min to remove the hexanes and other undesired materials of low vapor pressure. Subsequently, the solution is heated up to 260° C. under N₂-flow where the shell growth is performed. The amounts of the injection solutions are added as EXAMPLE 7. After that, Mn:ZnSe/ZnS core-shell nanocrystals are obtained.

### Example 19

### Synthesis of Dot-Shaped Cu₂₋ₓSe

0.2524 g (0.4 mmol) of CuSt₂ powder, 1.2 mmol OA, 2.4 mmol OAM, and 20 mL Se-A-1 precursor are added into a three-neck flask at room temperature, and the resulting reaction mixture is heated to 200° C. under a nitrogen flow for ˜90 min with the aid of magnetic stirring. The as-synthesized Cu₂₋ₓSe can be separated from the solution after adding a large amount of acetone followed by centrifugation. The precipitates, which can be well redispersed in hexanes, are used for subsequent characterization.

### Example 20

### Synthesis of Sn—X Capped Hexagonal Cu₂₋ₓSe Nanoplates with 3D Columnar Self-Assembly

First, a mixture of Sn(acac)₂Cl₂ (0.0776 g, 0.2 mmol), 1.2 mmol OA, 2.4 mmol OAM, and 20 mL Se-A-1 precursor is loaded in a 100 mL three-neck flask and heated to 120-150° C. under nitrogen to obtain a clear Sn—X complex solution. After it is cooled down to room temperature, 0.2524 g (0.4 mmol) of CuSt₂ powder is dispersed in it, the temperature is reheated to 200° C. under a nitrogen flow for ˜90 min. Finally, hexagonal Cu₂₋ₓSe nanoplates with 3D columnar self-assembly are obtained.

### Example 21

### Synthesis of Dot-Shaped PbSe Nanocrystals

0.2 mmol Pb(acac)₂, 0.8 mmol DA, 0.2 mmol OAM, 2 mL Se-A-1 and 5 mL of paraffin oil are added into a three-neck flask at room temperature; and the resulting mixture is heated to 120° C. under a nitrogen flow and kept at this temperature for 20 min. The solutions gradually changed from yellow to a deep-brown and last to dark colloidal solution. The solution is then cooled to room temperature, and excess ethanol is added to yield a dark precipitate, which is then separated by centrifuging.

### Example 22

### Synthesis of Cubic-Shaped PbSe Nanocrystals

The synthesis procedure is similar to the synthesis described in the synthesis of dot-shaped PbSe nanocrystals except that 0.2 mmol OAM is replaced by 2.4 mmol OAM and the resulting mixture is heated to 160° C.

### Example 23

### Synthesis of Dot-Shaped PbTe Nanocrystals

0.2 mmol Pb(acac)₂, 0.8 mmol DA 0.2 mmol OAM, 2 mL Te-TOPO, and 5 mL of paraffin oil are added into a three-neck flask at room temperature, and the resulting mixture is heated to 150° C. under a nitrogen flow and kept at this temperature for 20 min. The solutions gradually changed from yellow to a deep-brown and last to dark colloidal solution. The solution is then cooled to room temperature, and excess ethanol is added to yield a dark precipitate, which is then separated by centrifuging.

### Example 24

### Synthesis of Cubic-Shaped PbTe Nanocrystals

The synthesis procedure is similar to the synthesis described in the synthesis of dot-shaped PbTe nanocrystals except that 0.2 mmol OAM is replaced by 2.4 mmol OAM and the resulting mixture is heated to 180° C.

### Example 25

### Synthesis of CdTe Nanocrystals

0.2 mmol Cd(acac)₂, 0.8 mmol DA, 2 mL Te-TOPO or Te-DOPO, and 5 mL of paraffin oil are added into a three-neck flask at room temperature, and the resulting reaction mixture is heated to 220° C. under a nitrogen flow and kept at this temperature for 100 min. Then the reaction solution is cooled to room temperature. The resulting nanocrystals are precipitated from the reaction solution using acetone, and are redispersed in toluene.

### Example 26

### Synthesis of CdTeₓSe₁₋ₓ Nanocrystals

The synthesis procedure is similar to the synthesis described in the synthesis of CdTe nanocrystals (EXAMPLE 25) except that 2 mL Te-TOPO is replaced by 1 mL Se-ODE mixed with 1 mL Te-TOPO or Te-DOPO.

Preparation of precursors for the synthesis of Zn₁₋ₓCdₓSe nanocrystals: Stock solution for 0.1 M Cd precursor: A mixture (50 mL in total) of CdO (0.64 g, 5 mmol), oleic acid (5 mL), and 45 mL paraffin oil is loaded in a 100 mL three-neck flask and heated to 240° C. under nitrogen to obtain a colorless clear solution. Stock solution for 0.2 M Cd precursor: A mixture (375 mL in total) of CdO (9.6 g, 75 mmol), oleic acid (210 mL), and 165 mL paraffin oil is loaded in a 500 mL three-neck flask and heated to 240° C. under nitrogen to obtain a colorless clear solution. Stock solution for 0.2 M Zn precursor I: A mixture (100 mL in total) of ZnO (1.6274 g, 20 mmol), oleic acid (20 mL), and 80 mL paraffin oil is loaded in a 250 mL three-neck flask and heated to 300° C. under nitrogen to obtain a colorless clear solution. Stock solution for 0.2 M Zn precursor II: A mixture (375 mL in total) of ZnO (6.1 g, 75 mmol), oleic acid (210 mL), and 165 mL paraffin oil is loaded in a 500 mL three-neck flask and heated to 300° C. under nitrogen to obtain a colorless clear solution. Solution for Se precursor: It is made by degassing Se or SeO₂ (20 mmol), 200 mL of ODE in a 500 mL three-neck flask, then it is heated to 220° C. for 180 min under nitrogen. During this procedure, the color of the precursor changed from transparent to orange, then red, and finally turned into yellow. Solution for S precursor: The sulfur precursor solution (0.2 M) is prepared by heating a mixture of sulfur (1.92 g, 60 mmol) and ODE (300 mL) to 150° C. under nitrogen.

### Example 27

### Synthesis of Zn₁₋ₓCdₓSe (x=0.17, Zn:Cd=5:1) Nanocrystals

12 mL (1.2 mmol) Se precursor (Se or SeO₂ in ODE) and 50 mL paraffin oil is heated to 280° C. under nitrogen flow in a 250 mL flask. Next, take 7 mL mixture (Zn Precursor 15 mL, Cd Precursor 12 mL) is injected and temperature is lower to 260° C. for nanocrystal growth. Aliquots are taken at different intervals such as 20 s, 1 min, 5 min, 30 min and 60 min. The samples are purified by centrifugation (16,000 rpm for 10 minutes) several times after being precipitated with hexanes and methanol. The final products of Zn_{0.83}Cd_{0.17}Se nanocrystals are dispersed in hexane. The synthesis of other types of Zn₁₋ₓCdₓSe (x=0-1) is similar to Zn_{0.83}Cd_{0.17}Se. Series of Zn₁₋ₓCdₓSe (x=0-1) samples are shown in FIG. 11, with their corresponding Zn:Cd molar ratio of 200:1, 100:1, 50:1, 20:1, 10:1, 5:1, and <2:1, respectively. PL spectra cover from 450 nm to 650 nm.

### Example 28

### Synthesis of Zn₁₋ₓCdₓSe Core-Shell Nanocrystals with Blue and Green Emission

A typical synthesis is performed as follows 20 mL of ODE and 10 g of ODA are loaded into a 250 mL reaction vessel. The Zn₁₋ₓCdₓSe nanocrystals in hexanes (3.5 nm in diameter, 2.8×10⁻⁶ mol) are added, and the system is kept at 100° C. under N₂-flow for 30 min to remove the hexanes and other undesired materials of low vapor pressure. Subsequently, the solution is heated up to 240° C. under N₂-flow for the shell growth. The growth of shells are by inject the mixture of Zn and Se (or SeₓS₁₋ₓ, S) together with the ratio is 1:1. The amounts of the injection solutions for each step are as follows: Zn₁₋ₓCdₓSe cores with 3 monolayers of ZnSe shell, plus 3 monolayers of ZnSe_{0.8}S_{0.2} alloy shell, plus 3 monolayers of ZnSe_{0.5}S_{0.5} alloy shell, plus 3 monolayers of ZnSe_{0.2}S_{0.8} alloy shell, and 3 monolayers of ZnS shell. After that, Zn₁₋ₓCdₓSe core with a total of 15-monolayer ZnSe/ZnSeₓS₁₋ₓ/ZnS shell nanocrystals is obtained. We found that a period of 40 min is enough for Zn—Se, Zn—SeₓS₁₋ₓ, and Zn—S to grow. At last, the optical property is improved after reflux at 260° C. for one hour, the reaction mixture is allowed to cool to room temperature. After it is precipitated by acetone and followed hexane extraction, the further purification process is precipitation of nanocrystals with acetone or methanol.

### Example 29

### Synthesis of Zn₁₋ₓCdₓSe Core-Shell Nanocrystals with Red Emission

The process is the same as the synthesis of Zn₁₋ₓCdₓSe/ZnSe/ZnSeₓS₁₋ₓ/ZnS core-shell nanocrystals (EXAMPLE 28) except that ZnSeₓS₁₋ₓ precursor is replaced by Zn₁₋ₓCdₓS for the growth of the shell layer. A typical synthesis is performed as follows: 80 mL of ODE and 20 g of ODA are loaded into a 1000 mL reaction vessel. The Zn_{0.67}Cd_{0.33}Se (Zn:Cd molar ratio=2:1) nanocrystals in hexanes (3.5 nm in diameter, 3.1×10⁻⁶ mol) are added, the system is kept at 100° C. under N₂-flow for 30 min to remove the hexanes and other undesired materials of low vapor pressure. Subsequently, the solution is heated up to 240° C. where the shell growth is performed. The amounts of the injection solutions for each step are as follows: Zn_{0.67}Cd_{0.33}Se cores with 3 monolayers of CdS shell, plus 3 monolayers of Zn_{0.2}Cd_{0.8}S alloy shell, plus 3 monolayers of Zn_{0.5}Cd_{0.5}S alloy shell, plus 3 monolayers of Zn_{0.8}Cd_{0.2}S alloy shell, and 3 monolayers of ZnS shell. Finally, Zn_{0.67}Cd_{0.33}Se core with 15 monolayer CdS/Zn₁₋ₓCdₓS/ZnS shell nanocrystals is obtained.

### Example 30

### Synthesis of CuInSe₂ Nanocrystals

It is conducted by directly heating a mixture of surfactants and metal acetylacetates under a nitrogen flow. Typically, Cu(acac)₂ (0.0262 g, 0.1 mmol) and In(acac)₃ (0.0412 g, 0.1 mmol) are combined in Se-A-1 (5 mL) and heated to 230° C. under a nitrogen flow. After the reaction lasted certain time, different sizes of CuInSe₂ nanocrystals are synthesized.

### Example 31

### Synthesis of AgInSe₂ Nanocrystals

It is conducted by directly heating a mixture of surfactants and metal acetylacetates under a nitrogen flow. Typically, Ag(acac)₂ (0.1 mmol) and In(acac)₃ (0.0412 g, 0.1 mmol) are combined in Se-A-1 (5 mL) and heated to 230° C. under a nitrogen flow. After the reaction lasted certain time, different sizes of AgInSe₂ nanocrystals are synthesized.

### Example 32

Polymaleic anhydride (PMA) with low molecular weight (Mw=1000) is prepared as follows: 80 g (0.82 mol) maleic anhydride and 95 mL methylbenzene are loaded into a three-necked flask and heated to 70° C. 8 g (0.03 mol) benzoyl peroxide (BPO) and 50 mL methylbenzene are mixed at room temperature and added to the refluxing solution of maleic anhydride. Reflux is continued for 5 hours after the addition is complete. After the reaction mixture is cooled to the room temperature, the methylbenzene is poured out and 6 mL n-butanone is added to the flask. The mixture is heated to reflux at 86-90° C. for ½ hour and cooled to 60° C. PMA is then precipitated by adding 200 mL methylbenzene. The obtained product is finally dried at 50-60° C. for 24 h to remove the residual methylbenzene. The as-prepared PMA and aliphatic alcohol (n-butyl alcohol, n-octanol, n-dodecanol, and n-hexadecanol is used in the reaction, respectively; molar ratio of MA monomer/aliphatic alcohol ranged from 1:1 to 6:1) are dissolved in anhydrous acetone; to form the amphiphilic oligomer (polymaleic acid aliphatic alcohol ester, e.g., PMAA), the mixture required alkaline catalysis (triethylamine, wₜ=5%) and refluxing at 57° C. for 48 h. The obtained solution is rotary evaporated to remove most acetone. PMAA is then precipitated by adding excess of anhydrous toluene. The unreacted anhydrides later also converted to —COOH upon introducing water. The amphiphilic oligomer (PMAA) is dissolved in distilled water and the pH value of the solution is adjusted to 8-10 by sodium hydroxide or sodium carbonate. The purified nanocrystals (dispersed in chloroform) are added into PMAA solution and stirred for 24 h (room temperature, molar ratio of nanocrystals/PMAA is 1:200, volume ratio of pure water/chloroform is 9:1). The CdSe/ZnS nanocrystals originally dispersed in chloroform are forced to be dispersed in water during the slow evaporation of chloroform with the help of magnetic stir and this resulted in clear solution of water-soluble nanocrystals. The average size is around 12 nm. Excess PMAA oligomer is removed through centrifugation at 45000 to 60000 rpm for 30-60 min.

### Example 33

PMAA is dissolved in distilled water and the pH value of the solution is adjusted to 8-10 by sodium hydroxide or sodium carbonate. The purified CdSe/ZnS nanocrystals (dispersed in chloroform) are added into PMAA solution and stirred for 24 h (room temperature, molar ratio of nanocrystal/PMAA is 1:60, volume ratio of pure water/chloroform is 9:1). The CdSe/ZnS nanocrystals originally dispersed in chloroform are forced to be dispersed in water during the slow evaporation of chloroform with the help of magnetic stir and this resulted in a slightly turbid solution of water-soluble PL microspheres. The average size is around 95 nm. Excess PMAA oligomer is removed through centrifugation at 15000 to 20000 rpm for 30-60 min.

### Example 34

PMAA is dissolved in three distilled water and the pH value of the solution is adjusted to 8-10 by sodium hydroxide or sodium carbonate. The purified nanocrystals (dispersed in hexane) are added into PMAA solution and stirred for 24 h (room temperature, molar ratio of nanocrystals/PMAA is 1:80, volume ratio of pure water/chloroform is 5:1). The purified Ag/Au nanocrystals originally dispersed in chloroform are forced to be dispersed in water during the slow evaporation of chloroform with the help of magnetic stir and this resulted in clear solution of water-soluble nanocrystals. Excess PMAA oligomer is removed through centrifugation at 15000 to 20000 rpm for 30-60 min.

### Example 35

PMAA is dissolved in three distilled water and the pH value of the solution is adjusted to 8-10 by sodium hydroxide or sodium carbonate. The purified Fe₃O₄ nanocrystals (dispersed in methylene dichloride) are added into PMAA solution and stirred for 24 h (room temperature, molar ratio of nanocrystals/PMAA is 1:200, volume ratio of pure water/chloroform is 10:1). The Fe₃O₄ nanocrystals originally dispersed in methylene dichloride are forced to be dispersed in water during the slow evaporation of chloroform with the help of magnetic stir and this resulted in clear solution of water-soluble nanocrystals. Excess PMAA oligomer is removed through centrifugation at 15000 to 20000 rpm for 30-60 min.

Accordingly, the present invention provides a simple approach to synthesize monodisperse metal chalcogenides nanocrystals: which includes:

(a) combining metal precursor(s), ligand(s), and chalcogenide precursor(s) in a noncoordinating solvent at a temperature sufficient to form dot-shaped, rod-shaped, branch-shaped, wire-shaped nanocrystals;

(b) synthesis which is free of air-sensitive alkylphosphine such as trioctylphosphine (TOP) and tributylphosphine (TBP);

(c) metal oxide or salts and acids or amines reacting with each other in a noncoordinating solvent at 100-300° C. for 5 min-1 hour, wherein the molar ratio of the metal to the acid being 1:2 to 20;

(d) as Se precursor, Se or SeO₂ and acids or amines reacting with each other in a noncoordinating solvent at 100 to 400° C. for 5 min-20 hour, wherein the molar ratio of Se to the acid being 1:1 to 20;

(e) as Te precursor, Te or TeO₂ dissolving in TOPO at 100 to 400° C. for 5 min-20 hour; and

(f) reaction last 1 second to 10 hours to synthesize metal chalcogenides nanocrystals by adding S, Se, Te, or their mixed precursors.

In the above approach to synthesize monodisperse metal chalcogenides nanocrystals, it is also possible to use alternative precursors at temperature over 100° C. to carry out the reaction, wherein the chalcogenide precursor(s) can be made by S, Se, SeO₂, Te, TeO₂ or their mixtures, the S precursors include S or thiols (including hexanethiol, dodecanethiol, octadecanethiol) in 1-octadecene (ODE) or paraffin oil, the Se precursors include Se or SeO₂ with or without octadecylamine, oleic acid in ODE or paraffin oil, and the Te precursors including Te or TeO₂ in TOPO or DOPO.

It is worth mentioning that S with Se, Se with Te, or S with Te precursors at injection the same time or alternate addition can also be used, wherein the solvent for Se and SeO₂ is ODE or paraffin oil and the solvent for Te and TeO₂ is TOPO or DOPO.

In other words, all the nanocrystals are synthesized without air-sensitive alkylphosphine such as TOP or TBP. In particular, the noncoordinating solvent includes ODE, 1-eicosene, tetracosane, paraffin oil, paraffin wax, mineral oil, and/or their mixture; the metal precursors include metal oxide, metal halides, metal carbonates, metal perchlorate, metal nitrate, metal chloride, metal acetates, metal carboxylates and any other salt capable of dissolving in the ligand and coordinating solvent; the acids used to react with metal compounds include hexanoic acid, octanoic acid, decanoic acid, lauric acid, myristic acid, palmitic acid, stearic acid, oleic acid; and wherein the ligand includes dodecylamine, hexadecylamine, octadecylamine, stearic acid, lauric acid, hexanethiol, dodecanethiol, octadecanethiol, hexylphosphonic acid, tetradecylphosphonic acid, octadecylphosphonic acid, and trioctylphosphine oxide; the various molecular metal chalcogenide complexes (such as Sn—X: (Sn₂S₆)⁴⁻ or (Sn₂Se₆)⁴⁻ made from Sn(acac)₂Cl₂ or SnCl₄), can serve as convenient ligands to synthesize metal chalcogenides nanocrystals; the nanocrystals synthesis includes injection methods (metal precursor injection or chalcogenide precursor injection) or non-injection method (i.e. one-spot reaction); and this approach can be used to synthesize CdSe, ZnSe, Cu₂₋ₓSe, PbSe, MnSe, CdTe, SnSe, HgSe, AgSe, InSe, GaSe, MgSe, Al₂Se₃, ZnTe, HgTe, CuInSe₂, and CuInTe₂ nanocrystals; alloyed Zn₁₋ₓCdₓSe, CdSₓSe₁₋ₓ, CdSeₓTe₁₋ₓ, CdSₓTe₁₋ₓ, ZnSₓSe₁₋ₓ, ZnSeₓTe₁₋ₓ, ZnSₓTe₁₋ₓ, Zn₁₋ₓCdₓTe, Hg₁₋ₓCdₓTe, Zn₁₋ₓCdₓSe_{y}S_{1-y}, Zn₁₋ₓCdₓTe_{y}S_{1-y}, Zn₁₋ₓCdₓSe_{y}Te_{1-y}, CuInSₓSe₂₋ₓ, CuInSeₓTe₂₋ₓ, CuInSₓTe₂₋ₓ nanocrystals; and CdSe/ZnS, CdSe/CdS/ZnS, ZnSe/ZnS, PbSe/ZnS, MnSe/ZnSe, Cu₂₋ₓSe/CdS, Cu₂₋ₓSe/CdSe, Cu₂₋ₓSe/CdTe, Cu₂₋ₓSe/SnSe, CdTe/CdSe, ZnSe/ZnSeₓS₁₋ₓ/ZnS, CdS/Zn₁₋ₓCdₓS, CdSe/ZnSe/ZnSeₓS₁₋ₓ/ZnS, Zn₁₋ₓCdₓSe/ZnSe/ZnSeₓS₁₋ₓ/ZnS, Zn₁₋ₓCdₓSe/ZnS, Zn₁₋ₓCdₓSe/CdS/Zn₁₋ₓCdₓS/ZnS, CuInSe₂/ZnS, CuInSₓSe₂₋ₓ/ZnS, CuInSeₓTe₂₋ₓ/ZnS, CuInSₓTe₂₋ₓ/ZnS, CuInSe₂/ZnSe/ZnS, CuInSₓSe₂₋ₓ/ZnSe/ZnS, CuInSeₓTe₂₋ₓ/ZnSe/ZnS, CuInSₓTe₂₋ₓ/ZnSe/ZnS core/shell nanocrystals.

According to another aspect of the present invention, the present invention provides a versatile method to transfer nanocrystals into water. The nanocrystals can be monodisperse metal chalcogenides. Alternately, the nanocrystals can be metal oxides and noble metals.

According to the preferred embodiment of the present invention, the process is further described as follows:

First, solution A is obtained after dissolving hydrophobic nanocrystals in organic solvent (such as dichloromethane, chloroform and hexanes). The amphiphilic oligomer is then dissolved in distilled water to get solution B. The pH value of the solution B is adjusted to 8-10 by sodium hydroxide or sodium carbonate. The solution A are added into solution B (V_{B}>V_{A}) and stirred for 24 h (room temperature, molar ratio of nanocrystals/PMAA is 1:10-1:200, volume ratios of water/organic solvent is 3:1-9:1) to form an emulsion system.

After stirring, organic solvent was gradually evaporated from the emulsion system with the help of magnetic stir (during this process, the nanocrystals originally dispersed in organic solvent were successfully organized into aqueous microspheres) and a solution of water-soluble microspheres was obtained. Excess oligomer is removed through centrifugation in order to obtain aqueous nanocrystals.

In particular, the amphiphilic oligomers include carboxyl, amine, and hydroxyl oligomers; the nanocrystals include alloyed, core-shell, and doped semiconductors; the metal oxides include Fe₃O₄, γ-Fe₂O₃, FeO, and MnO; the metals include Au, Ag, alloyed AuAg, PtAu; the bifunctional materials include Fe₃O₄—CdSe/ZnS; Fe₃O₄—Zn₁₋ₓCdₓSe/ZnS, Fe₃O₄—Zn₁₋ₓCdₓSe/ZnSe/ZnSeₓS₁₋ₓ/ZnS, Fe₃O₄—CuInSe₂/ZnS, Fe₃O₄—CuInSₓSe₂₋ₓ/ZnS, Fe₃O₄—CuInSe₂/ZnSe/ZnS, Fe₃O₄—Au, Fe₃O₄—Ag, Au—CdSe/ZnS; Au—Zn₁₋ₓCdₓSe/ZnS, Au—Zn₁₋ₓCdₓSe/ZnSe/ZnSeₓS₁₋ₓ/ZnS, Au—CuInSe₂/ZnS, Au—CuInSₓSe₂₋ₓ/ZnS, and Au—CuInSe₂/ZnSe/ZnS

Preferably, the mixed solution is stirred for 2-30 h under 600-2000 rpm, the pH value of solution B is 8-10, the molar ratio of oligomer/nanocrystals is 10:1-200:1, and the volume ratio of water/organic solvent is varied from 3:1 to 9:1.

It is worth mentioning that the method or process of the present invention can be applied to prepare or manufacture a biological labeling or imaging reagent, a light-emitting diode, solid state lighting, or a solar cell device.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

### REFERENCES CITATION LIST

### Patent Literature

U.S. Pat. No. 6,576,291 Bawendi et al
U.S. Pat. No. 6,444,143 Bawendi et al
U.S. Pat. No. 7,105,051 Peng et al
U.S. Pat. No. 6,872,249 Peng et al

### Non-Patent Literature

C. Murray, et al. “Synthesis and Characterization of Nearly Monodisperse CdE (E=S, Se, Te) Semiconductor Nanocrystallites”, J. Am. Chem. Soc., 115, 8706, (1993).
L. S. Li, et al. “High Quality ZnSe and ZnS Nanocrystals Formed by Activating Zinc Carboxylate Precursors”, Nano Lett. 4, 2261, (2004).
Z. Deng, et al. “A New Route to Zinc-Blende CdSe Nanocrystals: Mechanism and Synthesis”, J. Phys. Chem. B 109, 16671, (2005).
J. Jasieniak, et al. “Phosphine-Free Synthesis of CdSe Nanocrystals”, J. Phys. Chem. B 109, 20665, (2005).
R. Xie, et al. “Synthesis and Characterization of Highly Luminescent CdSe-Core CdS/Zn0.5Cd0.5S/ZnS Multishell Nanocrystals”, J. Am. Chem. Soc. 127, 7480 (2005).
Huaiben Shen, et al. “High Quality Synthesis of Monodisperse Zinc-Blende CdSe and CdSe/ZnS Nanocrystals with Phosphine-Free Method” CrystEngComm, 11, 1733, (2009).
Huaiben Shen, et al. “Controllable Synthesis of High Quality ZnSe, ZnSe/ZnS, and Cu-, Mn-doped ZnSe Nanocrystals by Phosphine-free Method” Dalton Transactions, 10534, (2009).
Jin Zhong Niu, et al. “Investigation on Phosphine-free Synthesis of CdSe Nanocrystals by Cadmium Precursor Injection” New J. Chem., 33, 2114, (2009).
Jin Zhong Niu, et al. “Controlled synthesis of high quality type-II/type-I CdS/ZnSe/ZnS core/shell1/shell2 nanocrystals” Dalton Transactions, 39, 3308, (2010).
Changhua Zhou, et al. “A Versatile Method for the Preparation of Water-Soluble Amphiphilic Oligomer-Coated Semiconductor Quantum Dots with High Fluorescence and Stability” J. Coll. Inter. Sci., 344, 279, (2010).
Changhua Zhou, et al. “Formation of water-soluble gold and silver nanocrystals using a phase transfer method based on surface-bound interactions” Colloids and Surfaces A: Physicochemical and Engineering Aspects, 335, 139, (2010).
Huaiben Shen, et al. “Size- and shape-controlled synthesis of ZnSe nanocrystals using SeO₂ asselenium precursor” Dalton Transactions, 11432, (2010).
Huaiben Shen, et al. “Size- and Shape-Controlled Synthesis of CdTe and PbTe Nanocrystals Using Tellurium Dioxide as the Tellurium Precursor” Chem Mater 4757, (2010).

What is claimed is:

1. A method of monodisperse metal chalcogenides nanocrystals synthesis, comprising the steps of:
(a) providing a first composition of nanocrystal by combining metal precursor(s), ligand(s), and chalcogenide precursor(s) in a first noncoordinating solvent at a first preset reaction temperature, wherein the metal precursor can be dissolved in the ligand and the first noncoordinating solvent and the first preset reaction temperature is sufficient for forming the first composition of nanocrystal in dot-shape, rod shape, branch shape and wire shape to obtain a final product of highly monodisperse metal chalcogenide nanocrystals;
(b) providing a core/shell nanocrystals-synthesis, which provides a second composition through a second reaction by pre-selected core nanocrystals reacting with a metal composition consisting of metal oxide or salts with an additive composition consisting of acid(s) or amine(s) and chalcogenide precursor(s) in a second noncordinating solvent at a second preset temperature of 100-350° C. for a second preset period of time of 5 min-10 days to obtain a final product of highly monodisperse core/shell metal chalcogenide nanocrystals;
(c) adding one or more phosphine-free metal precursor(s), ligand(s), and chalcogenide precursor(s) to the first and the second compositions to obtain a final product of highly monodisperse core/multi-shell metal chalcogenide nanocrystals.

2. The method, as recited in claim 1, wherein metal oxide or salt(s) and acid(s) or amine(s) reacting with each other in a noncoordinating solvent at 100-350° C. for 5 min to 1 hour, the molar ratio of the metal to the acid being 1:2 to 20; wherein the air-sensitive phosphine-free precursor is selected from the group consisting of S, Se and Te precursors, wherein the S precursor is selected from the group consisting of S and thiols in 1-octadecene (ODE) or paraffin oil, wherein the thiols include hexanethiol, dodecanethiol and octadecanethiol, wherein the Se precursor is prepared by reacting Se or SeO₂ with acids or amines in a noncoordinating solvent for preparing Se precursor at 100 to 300° C. for 5 min-20 hour, wherein a molar ratio of the Se to the acid(s) or amine(s) is 1:1 to 20, wherein the Te precursor is prepared by dissolving Te or TeO₂ in TOPO or DOPO at 100 to 400° C. for 5 min-20 hour.

3. The method, as recited in claim 1, wherein the phosphine-free precursor is an alternative precursor when the preset reaction temperature is over 100° C. and reaction time last over 1 second which is sufficient to carry out the reaction to obtain the core, core/shell, and core/multi-shell metal chalcogenides nanocrystals.

4. The method, as recited in claim 1, wherein the phosphine-free precursor is added by injection with a solvent, wherein the solvent for Se and SeO₂ is ODE or paraffin oil and the solvent for Te and TeO₂ is TOPO or DOPO, wherein when more than one phosphine-free precursors are added by injection, the phosphine-free precursors are added at the same time or separately.

5. The method, as recited in claim 1, wherein the second noncoordinating solvent is selected from one or more of the group consisting of ODE, 1-eicosene, tetracosane, paraffin oil, paraffin wax, and mineral oil.

6. The method, as recited in claim 1, wherein the metal precursor is selected from the group consisting of metal oxide, metal halides, metal carbonates, metal perchlorate, metal nitrate, metal chloride, metal acetates, and metal carboxylates.

7. The method, as recited in claim 1, wherein the ligand is selected from the group consisting of dodecylamine, hexadecylamine, octadecylamine, stearic acid, lauric acid, hexanethiol, dodecanethiol, octadecanethiol, hexylphosphonic acid, tetradecylphosphonic acid, octadecylphosphonic acid, and trioctylphosphine oxide.

8. The method, as recited in claim 1, wherein the additive composition is selected from the group consisting of hexanoic acid, octanoic acid, decanoic acid, lauric acid, myristic acid, palmitic acid, stearic acid, and oleic acid.

9. The method, as recited in claim 1, further comprising a step of
(a.1) providing a molecular metal chalcogenide complex as the ligand and the chalcogenide precursor in the step (a),
wherein the molecular metal chalcogenide complex is Sn—X: (Sn₂S₆)⁴⁻ or (Sn₂Se₆)⁴⁻ made from Sn(acac)₂Cl₂ or SnCl₄.

10. The method, as recited in claim 1, wherein in step (a), the first composition is prepared by injection method including metal precursor injection or chalcogenide precursor injection or non-injection method which is one-spot reaction method.

11. The method, as recited in claim 1, wherein the final product is a nanocrystal selected from the group consisting of CdS, ZnS, Cu₂S, PbS, CdSe, ZnSe, Cu₂₋ₓSe, PbSe, MnSe, CdTe, SnSe, HgSe, AgSe, InSe, GaSe, MgSe, Al₂Se₃, ZnTe, HgTe, CuInSe₂, and CuInTe₂.

12. The method, as recited in claim 9, wherein the final product is a nanocrystal selected from the group consisting of CdS, ZnS, Cu₂S, PbS, CdSe, ZnSe, Cu₂₋ₓSe, PbSe, MnSe, CdTe, SnSe, HgSe, AgSe, InSe, GaSe, MgSe, Al₂Se₃, ZnTe, HgTe, CuInSe₂, and CuInTe₂.

13. The method, as recited in claim 1, wherein the final product is an alloy nanocrystal selected from the group consisting of alloyed Zn₁₋ₓCdₓSe, CdSₓSe₁₋x, CdSeₓTe₁₋x, CdSₓTe₁₋ₓ, ZnSₓSe₁₋ₓ, ZnSeₓTe₁₋ₓ, ZnSₓTe₁₋ₓ, Zn₁₋ₓCdₓTe, Hg₁₋ₓCdₓTe, Zn₁₋ₓCdₓSe_{y}S_{1-y}, Zn₁₋ₓCdₓTe_{y}S_{1-y}, Zn₁₋ₓCdₓSe_{y}Te_{1-y}, CuInSₓSe₂₋ₓ, CuInSeₓTe₂₋ₓ, and CuInSₓTe₂₋ₓ nanocrystals.

14. The method, as recited in claim 9, wherein the final product is an alloy nanocrystal selected from the group consisting of alloyed Zn₁₋ₓCdₓSe, CdSₓSe₁₋x, CdSeₓTe₁₋x, CdSₓTe₁₋x, ZnSₓSe₁₋ₓ, ZnSeₓTe₁₋ₓ, ZnSₓTe₁₋ₓ, Zn₁₋ₓCdₓTe, Hg₁₋ₓCdₓTe, Zn₁₋ₓCdₓSe_{y}S_{1-y}, Zn₁₋ₓCdₓTe_{y}S_{1-y}, Zn₁₋ₙCdₓSe_{y}Te_{1-y}, CuInSₓSe₂₋ₓ, CuInSeₓTe₂₋ₓ, and CuInSₓTe₂₋ₓ nanocrystals.

15. The method, as recited in claim 1, wherein the final product is a core/shell or core/multi-shell nanocrystal selected from the group consisting of CdSe/ZnS, CdSe/CdS/ZnS, ZnSe/ZnS, PbSe/ZnS, MnSe/ZnSe, Cu₂₋ₓSe/CdS, Cu₂₋ₓSe/CdSe, Cu₂₋ₓSe/CdTe, Cu₂₋ₓSe/SnSe, CdTe/CdSe, ZnSe/ZnSeₓS₁₋ₓ/ZnS, CdS/Zn₁₋ₓCdₓS, CdSe/ZnSe/ZnSeₓS₁₋ₓ/ZnS, Zn₁₋ₓCdₓSe/ZnSe/ZnSeₓS₁₋ₓ/ZnS, Zn₁₋ₓCdₓSe/ZnS, Zn₁₋ₓCdₓSe/CdS/Zn₁₋ₓCdₓS/ZnS, CuInSe₂/ZnS, CuInSₓSe₂₋ₓ/ZnS, CuInSeₓTe₂₋ₓ/ZnS, CuInSₓTe₂₋ₓ/ZnS, CuInSe₂/ZnSe/ZnS, CuInSₓSe₂₋ₓ/ZnSe/ZnS, CuInSeₓTe₂₋ₓ/ZnSe/ZnS, and CuInSₓTe₂₋ₓ/ZnSe/ZnS nanocrystals.

16. The method, as recited in claim 9, wherein the final product is a core/shell or core/multi-shell nanocrystal selected from the group consisting of CdS/ZnS, ZnS/SnS, Cu₂S/SnS, PbS/SnS, CdSe/ZnS, CdSe/CdS/ZnS, ZnSe/ZnS, PbSe/ZnS, MnSe/ZnSe, Cu₂₋ₓSe/CdS, Cu₂₋ₓSe/CdSe, Cu₂₋ₓSe/CdTe, Cu₂₋ₓSe/SnSe, CdTe/CdSe, ZnSe/ZnSeₓS₁₋ₓ/ZnS, CdS/Zn₁₋ₓCdₓS, CdSe/ZnSe/ZnSeₓS₁₋ₓ/ZnS, Zn₁₋ₓCdₓSe/ZnSe/ZnSeₓS₁₋ₓ/ZnS, Zn₁₋ₓCdₓSe/ZnS, Zn₁₋ₓCdₓSe/CdS/Zn₁₋ₓCdₓS/ZnS, CuInSe₂/ZnS, CuInSₓSe₂₋ₓ/ZnS, CuInSeₓTe₂₋ₓ/ZnS, CuInSₓTe₂₋ₓ/ZnS, CuInSe₂/ZnSe/ZnS, CuInSₓSe₂₋ₓ/ZnSe/ZnS, CuInSeₓTe₂₋ₓ/ZnSe/ZnS, and CuInSₓTe₂₋ₓ/ZnSe/ZnS nanocrystals.

17. A method of preparing water-soluble nanocrystal from organic solvent-soluble nanocrystal, adapted for applying in industrial manufacture, comprising the steps of
(a) preparing a solution A by dissolving the organic solvent-soluble purified nanocrystals in organic solvent;
(b) preparing a solution B by dissolving an amphiphilic oligomer in distilled water and adjusting the pH of solution B to 8-10; and
(c) mixing the solution A and solution B (V_{B}>V_{A}) to form an emulsion system under magnetic stirring; and
(d) evaporating the organic solvent from the mixed solution at room temperate to obtain the water soluble nanocrystals or photoluminescent microspheres, wherein the molar ratio of nanocrystal/PMAA is 1:10-1:200 and the volume ratios of water/organic solvent is 3:1-9:1.
thereby the water soluble nanocrystals or photoluminescent microspheres are capable of being applied at industrial level for biological labeling, imaging reagent, and manufacture of light-emitting diode, solid state lighting, and a solar cell device.

18. The method, as recited in claim 17, wherein the amphiphilic oligomer is selected from the group consisting of carboxyl, amine, and hydroxyl oligomer. The alkyl chain length of the amphiphilic oligomer is capable of being tuned from C4 to C16. The molar ratio of hydrophobic to hydrophilic groups varies from 1:1 to 1:10.

19. The method, as recited in claim 17, wherein in the step (d), the mixed solution is stirred for 2-30 hour under 600-2000 rpm through magnetic stirring so as to speeding up the evaporation and removal of the organic solvent in excess.

20. The method, as recited in claim 17, wherein a molar ratio of oligomer to nanocrystal is 10:1-200:1, and a volume ratio of water to organic solvent is from 3:1 to 9:1.

21. The method, as recited in claim 17, wherein the organic solvent-soluble nanocrystal is selected from the group consisting of monodisperse metal chalcogenides, metal oxides, and noble metals.

22. The method, as recited in claim 17, wherein the organic solvent is selected from the group consisting of dichloromethane, chloroform, and hexanes, wherein the pH value of the solution B is adjusted by sodium hydroxide or sodium carbonate.

23. The method, as recited in claim 21, wherein the monodisperse metal chalcogenides nanocrystal is selected from the group consisting of alloyed, core-shell, and doped semiconductors.

24. The method, as recited in claim 21, wherein the metal oxide is selected from the group consisting of Fe₃O₄, γ-Fe₂O₃, FeO, and MnO, wherein metal of the monodisperse metal chalcogenides nanocrystal is selected from the group consisting of Au, Ag, alloyed AuAg and PtAu, wherein bifunctional nanocrystal is selected from the group consisting of Fe₃O₄—CdSe/ZnS; Fe₃O₄—Zn₁₋ₓCdₓSe/ZnS, Fe₃O₄—Zn₁₋ₓCdₓSe/ZnSe/ZnSeₓS₁₋ₓ/ZnS, Fe₃O₄—CuInSe₂/ZnS, Fe₃O₄—CuInSₓSe₂₋ₓ/ZnS, Fe₃O₄—CuInSe₂/ZnSe/ZnS, Fe₃O₄—Au, Fe₃O₄—Ag, Au—CdSe/ZnS; Au—Zn₁₋ₓCdₓSe/ZnS, Au—Zn₁₋ₓCdₓSe/ZnSe/ZnSeₓS₁₋ₓ/ZnS, Au—CuInSe₂/ZnS, Au—CuInSₓSe₂₋ₓ/ZnS, and Au—CuInSe₂/ZnSe/ZnS.
